(19) United States
(12) Patent Application Publication
(10) Pub. No.: US 2025/0317457 A1
(43) Pub. Date: Oct. 9, 2025

(54) EDGE-BASED PACKET PROCESSING FOR APPLICATION RECOGNITION AND INTRUSION DETECTION

(71) Applicant: Cisco Technology, Inc., San Jose, CA (US)

(72) Inventors: Peiman Amini, Fremont, CA (US); Niloo Bahadori, Greensboro, NC (US); Jerome Henry, Pittsboro, NC (US); Bahador Amiri, Saratoga, CA (US)

(21) Appl. No.: 19/051,089

(22) Filed: Feb. 11, 2025

Related U.S. Application Data
(60) Provisional application No. 63/574,184, filed on Apr. 3, 2024.

(51) Int. Cl. H04L 9/40

(52) U.S. Cl. CPC H04L 63/1425; H04L 63/0428

(57) ABSTRACT

Devices, systems, methods, and processes for facilitating edge-based packet processing for application recognition and intrusion detection are described herein. A packet inspection logic, deployed at an edge-based network device, receives a packet comprising header(s) and a payload, generates a sequence of tokens, and encodes the sequence of tokens into a unified representation that is suitable for both application recognition and intrusion detection. The packet inspection logic provides the unified representation as a shared input to a plurality of classifiers and obtains a set of classification results as output of the plurality of classifiers. The set of classification results indicates an application associated with the packet and whether the packet is a legitimate packet or an anomalous packet. This approach enhances real-time decision-making at the edge-based network device for application recognition and intrusion detection.

### CROSS-REFERENCE TO RELATED APPLICATIONS

This application claims priority to U.S. Provisional Application No. 63/574,184, filed Apr. 3, 2024, the entirety of which is incorporated herein by reference.

### FIELD

The present disclosure relates to wireless communication. More particularly, the present disclosure relates to edge-based packet processing for application recognition and intrusion detection.

### BACKGROUND

With the exponential growth of digital technologies and increasing dependence on interconnected networks, the need for robust network security is becoming more important over time. Most organizations are heavily dependent on their network infrastructure to conduct business, communicate with clients and partners, and store sensitive information. Consequently, protection of networked systems from unauthorized access, disruption, and data breaches has become a top priority. Network security may aim to protect integrity, confidentiality, and availability of data and resources on a network, thereby safeguarding an organization's data, systems, and resources against threats, unauthorized access, data breaches, attacks, malware, damage, and system vulnerabilities. Network security may involve implementing security policies and deploying network software and hardware to protect the network, its infrastructure, and all its traffic from external cyberattacks and protect all assets and resources available via the network from unauthorized access. In the field of network security and management, functions such as application recognition and intrusion detection play an important role. These functions rely heavily on deep packet inspection, which involves analyzing network packets to extract meaningful insights. In deep packet inspection, packet headers and payloads are examined to identify applications and detect anomalies or threats.

However, current approaches to packet inspection and analysis have notable limitations. For example, existing methodologies in packet-level analysis largely focus on improving the performance of individual classification tasks, such as application recognition or intrusion detection, in isolation. While these approaches have made significant strides in specific domains, they often fail to address the broader issue of creating effective packet representations that can serve multiple tasks. The diversity of packet structures, coupled with the challenge of creating a universal representation that addresses the differing needs of application recognition and intrusion detection, hinders the effectiveness of traditional methods. Encrypted traffic further complicates analysis by rendering payload data inaccessible without decryption keys, diminishing the reliability of content-based inspection. Additionally, the dependence on external processing entities introduces latency and risks data loss during downsampling, which is particularly problematic for time-sensitive tasks such as application recognition or intrusion detection.

### SUMMARY OF THE DISCLOSURE

Systems and methods for facilitating edge-based packet processing for application recognition and intrusion detection in accordance with embodiments of the disclosure are described herein. In many embodiments, a network device comprises a processor, a network interface controller, and a memory. The network interface controller is configured to provide access to a network. The memory is coupled to the processor and comprises a packet inspection logic. The packet inspection logic is configured to receive at least one packet comprising one or more headers and a payload, generate a sequence of tokens based on the one or more headers and the payload, encode the sequence of tokens into a unified representation by utilizing one or more encoders, provide the unified representation as a shared input to a plurality of classifiers, and obtain a set of classification results for the received at least one packet as output of the plurality of classifiers.

In a number of embodiments, the sequence of tokens comprises one or more first tokens that are generated based on the one or more headers and one or more second tokens that are generated based on the payload.

In a variety of embodiments, the payload corresponds to one of plaintext or encrypted text.

In further embodiments, based on the payload corresponding to the encrypted text, generating the one or more second tokens comprises converting the encrypted text into one or more codes and tokenizing the one or more codes to generate the one or more second tokens.

In still further embodiments, the unified representation indicates a semantic pattern and a byte-level pattern of the received at least one packet.

In more embodiments, the unified representation comprises a first representation indicating the semantic pattern of the received at least one packet, and one or more second representations indicating the byte-level pattern of the received at least one packet.

In still more embodiments, a second representation of the one or more second representations corresponds to a token of the sequence of tokens.

In additional embodiments, the packet inspection logic is further configured to generate one or more context-aware alerts based on the set of classification results.

In still additional embodiments, the packet inspection logic is further configured to propagate a feedback from the plurality of classifiers to the one or more encoders, and tune at least one parameter of the one or more encoders based on the propagated feedback.

In numerous embodiments, the network device corresponds to an access point in the network.

In several additional embodiments, a first classifier of the plurality of classifiers corresponds to an application recognition classifier and a second classifier of the plurality of classifiers corresponds to an intrusion detection classifier.

In yet several embodiments, the set of classification results includes an application recognition result indicating an application associated with the received at least one packet and an intrusion detection result indicating whether the received at least one packet is a legitimate packet or an anomalous packet.

In several embodiments, the application recognition result is obtained as the output of the first classifier and the intrusion detection result is obtained as the output of the second classifier.

In numerous additional embodiments, the plurality of classifiers corresponds to adaptive classifiers that re-learn based on the set of classification results.

In yet more embodiments, a device comprises a processor and a memory. The memory is communicatively coupled to the processor and the memory comprises a packet inspection logic configured to train a multi-task learning model comprising a first classifier for application recognition and a second classifier for intrusion detection. During the training the first classifier generates an application recognition output and utilizes the application recognition output as one of an excitatory influence or an inhibitory influence on the second classifier. Further during the training, the second classifier generates an intrusion detection output and utilizes the intrusion detection output as one of an excitatory influence or an inhibitory influence on the application recognition classifier.

In further more embodiments, the packet inspection logic is further configured to deploy the trained multi-task learning model on an edge-based network device for network traffic classification.

In still yet more embodiments, the device corresponds to an edge-based network device.

In numerous other embodiments, a network traffic classification method comprises receiving, at an edge device in a network, at least one packet comprising one or more headers and a payload, generating a sequence of tokens based on the one or more headers and the payload, encoding the sequence of tokens into a unified representation by utilizing one or more encoders at the edge device, providing the unified representation as a shared input to a plurality of classifiers at the edge device, and obtaining a set of classification results for the received at least one packet as output of the plurality of classifiers.

In many further embodiments, the set of classification results includes an application recognition result indicating an application associated with the received packet and an intrusion detection result indicating whether the received at least one packet is a legitimate packet or an anomalous packet.

In still yet further embodiments, the network traffic classification method further comprises generating one or more context-aware alerts based on the set of classification results.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a packet inspection logic may operate in accordance with various embodiments of the disclosure;

FIG. 2 is a conceptual block diagram of a network traffic classification framework in accordance with various embodiments of the disclosure;

FIG. 3 is a diagram that illustrates a liquid neural network utilized in edge-based packet processing for application recognition and intrusion detection in accordance with various embodiments of the disclosure;

FIG. 4 is a diagram depicting various subsets of artificial intelligence in accordance with various embodiments of the disclosure.

FIG. 5 illustrates different methods of machine-based learning in accordance with various embodiments of the disclosure;

FIG. 6 is a machine learning lifecycle in accordance with various embodiments of the disclosure;

FIG. 7 is an exemplary neural network in accordance with various embodiments of the disclosure;

FIG. 8 is a flowchart depicting a process for edge-based processing of network traffic for application recognition and intrusion detection in accordance with various embodiments of the disclosure;

FIG. 9 is a flowchart depicting a process for network traffic classification in accordance with various embodiments of the disclosure;

FIG. 10 is a flowchart depicting a process for tuning network traffic classification in accordance with various embodiments of the disclosure;

FIG. 11 is a flowchart depicting a process for deploying a trained multi-task learning model in accordance with various embodiments of the disclosure; and

FIG. 12 is a conceptual block diagram of a device suitable for configuration with a packet inspection logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can facilitate edge-based packet processing for application recognition and intrusion detection. The exponential growth of Internet traffic, driven by the rapid proliferation of new applications and services, have greatly increased the complexity of network management and analysis. Application recognition and intrusion detection are two such functions that ensure network integrity and seamless performance. Both these functions heavily depend on deep packet inspection, a process that analyzes network packets to extract actionable insights. Deep packet inspection generally involves examination of packet headers and payloads to identify specific applications and detect anomalies or potential threats. While existing methods for packet-level analysis have improved performance for individual tasks such as application recognition and intrusion detection, they largely operate in isolation. Real-time processing requirements further necessitate that access points (APs) handle packet analysis locally, as outsourcing to external systems introduces delays and risks the loss of vital data. Current methodologies further face significant limitations in addressing the broader requirements of modern network traffic analysis. Packet diversity, resulting from differences in packet structure, format, and encapsulation across various protocols, complicates the development of universal encoding methods. Additionally, the rise of encrypted traffic limits the accessibility of payload data, reducing the efficacy of traditional content-based inspection techniques. Further, the current methodologies treat network analysis tasks in isolation. These approaches often fail to create a unified packet representation capable of serving multiple functions, such as application recognition and intrusion detection, simultaneously. A unified representation of packet data may offer the potential to bridge the gap between application recognition and intrusion detection by enabling these functions to complement and enhance each other. By leveraging insights gained from one function to improve the performance of the other, such a framework could provide a more comprehensive understanding of network traffic patterns. However, current technologies do not fully leverage this interconnected approach, leaving significant room for improvement.

Therefore, to address these challenges, the present disclosure provides a solution that encrypted traffic, and real-time processing demands while simultaneously optimizing the capabilities of application recognition and intrusion detection. The present disclosure may ensure to navigate the complexities of packet structure variability, adapt to the specific requirements of application recognition and intrusion detection, and exploit the synergies between them. In other words, the present disclosure balances the interdependencies between different functions by facilitating a shared learning environment for effective application recognition and intrusion detection and providing a network device that performs edge-based packet processing for application recognition and intrusion detection. The network device may be an edge-based network device (e.g., an access point, an edge server, an edge gateway, a router, or a network switch), or the like. The network device may include a packet inspection logic that may be configured to manage joint application recognition and intrusion detection functions to improve network quality.

In numerous embodiments, the packet inspection logic may be deployed or installed in the network device. In many embodiments, the packet inspection logic may receive at least one packet (hereinafter referred to as “the packet”). The at least one packet may refer to a network packet that may be a basic unit of data grouped together and transferred over a network. The network packet may be a part of a complete message and carry pertinent address information that may help identify a source address and intended recipient of the message. The packet may include one or more headers and a payload. The one or more headers may include instructions related to the data in the packet and the payload, which may be plaintext or encrypted, may include content of the packet.

In a variety of embodiments, the packet inspection logic may be configured to generate a sequence of tokens based on the one or more headers and the payload of the packet. For example, the packet inspection logic may utilize a tokenizer to generate the sequence of tokens. The tokenizer upon receiving the packet may convert packet data to a non-sensitive equivalent, referred to as “the sequence of tokens”, representing multiple features of the packet. The sequence of tokens may include one or more first tokens generated based on the one or more headers. For example, the one or more first tokens may represent various features, such as a source address, a destination address, one or more port numbers, a packet size, one or more protocol types, one or more timestamps, or the like captured in the one or more headers of the packet. The sequence of tokens may further include one or more second tokens generated based on the payload. If the payload corresponds to the encrypted text, the one or more second tokens may be generated by converting the encrypted text into one or more codes, for example, hexadecimal codes, binary codes, unicode, American Standard Code for Information Interchange (ASCII) or the like. The one or more codes may be then tokenized to generate the one or more second tokens.

In a number of embodiments, the packet inspection logic may be further configured to encode the sequence of tokens into a unified representation. In an example, the packet inspection logic may utilize one or more encoders to encode the sequence of tokens into the unified representation. The unified representation may include a first representation that indicates a semantic pattern of the packet and one or more second representations that indicate a byte-level pattern of the packet. A second representation of the one or more second representations may correspond to a token of the sequence of tokens. For example, the one or more second representations may have a 1:1 correspondence with the sequence of tokens.

“Semantic pattern” may correspond to functional and contextual meaning of a packet's structure, focusing on what the packet represents within the larger network operation, rather than just its raw binary content. For example, the packet can be an HTTP request. In this example, raw data of the packet may include various byte sequences representing different features or fields such as the source address, destination port, HTTP method, path, headers, or the like. The semantic pattern may refer to how these features or fields are interpreted and understood in the context of the HTTP protocol. In other words, the first representation may indicate a collective context captured by the one or more first tokens and the one or more second tokens. Thus, the first representation may integrate information from the one or more first tokens and the one or more second tokens of the packet. “Byte-level pattern” may represent low-level context associated with the packet. For example, the one or more second representations may indicate specific byte-level pattern, such as raw structure of the packet at a granular level. These individual second representations, when combined, form a detailed and precise description of the byte-level pattern of the packet.

In further embodiments, the packet inspection logic may be further configured to provide the unified representation as a shared input to a plurality of classifiers. The plurality of classifiers may be associated with a multi-task learning (MTL) model and may include a first classifier and a second classifier, for example. The first classifier may correspond to an application recognition classifier and the second classifier may correspond to an intrusion detection classifier. The packet inspection logic may then obtain a set of classification results for the received packet as output of the plurality of classifiers. For example, the set of classification results may include an application recognition result obtained as an output of the application recognition classifier indicating an application associated with the received packet. The set of classification results may further include an intrusion detection result obtained as an output of the inspection detection classifier indicating whether the received packet is a legitimate packet or an anomalous packet.

In still further embodiments, the packet inspection logic may be further configured to generate one or more context-aware alerts based on the set of classification results. The one or more context-aware alerts may provide actionable insights based on the detected context of the set of classification results, such as identifying malicious activity, unusual traffic patterns, or specific application usage. By incorporating contextual information from the set of classification results, the one or more context-aware alerts can prioritize important issues, reduce false positives, and provide meaningful details to enhance decision-making for security and network management. Such one or more context-aware alerts can be provided to higher-level systems, such as network administration tools, intrusion prevention systems, or other deep packet inspection systems, allowing them to take appropriate action.

In more embodiments, the plurality of classifiers may correspond to adaptive classifiers that re-learn based on the set of classification results. Further, the packet inspection logic may be configured to propagate a feedback from the plurality of classifiers to the one or more encoders. The feedback propagated may aid in tuning at least one parameter of the one or more encoders and/or the tokenizer. Accordingly, the feedback loop may ensure that the one or more encoders adapt representation encoding to generate subsequent unified representations based on the performance of the plurality of classifiers. For example, if one or more patterns (byte-level pattern or semantic pattern) in a previous unified representation led to the misclassification of the packet, the feedback can adjust one or more weights of the one or more encoders or tokenization approach of the tokenizer to capture relevant patterns in the subsequent unified representations.

In still further embodiments, a device may be configured to train the MTL model based on synthetic traffic generated to mimic a new application and is interleaved with well-known traffic before being introduced into the MTL model. The device may be the network device or another device such as a cloud-based server, wireless local access network controller (WLC), edge-based servers, or the like. “Synthetic traffic” may refer to artificially generated network data designed to mimic real-world application or malicious patterns for testing and analysis purpose. The synthetic traffic may further include historical traffic data processed by a plurality of APs that may be further tokenized and encoded into a unified representation.

In several embodiments, during training, the first classifier may generate an application recognition output from the synthetic traffic received by the MTL model and utilize the application recognition output as one of an excitatory influence or an inhibitory influence on the second classifier. Similarly, the second classifier may generate an intrusion detection output from the synthetic traffic and utilize the intrusion detection output as one of an excitatory influence or an inhibitory influence on the application recognition classifier. Initially, the synthetic traffic may be flagged as suspicious or unknown with a high probability. However, as more of the synthetic traffic may be injected to the MTL model, the probability of the synthetic traffic being flagged as malicious or unknown decreases linearly due to interconnections between the first classifier and the second classifier. That is to say, the output of the first classifier becomes an input for a learning phase of the second classifier and vice versa. Once the synthetic traffic is fully learned and no longer reported as malicious, variations may be introduced into the synthetic traffic pattern, such as changes in payload length or packet density over time. The MTL model may then compute correlations between the deviations and the outputs of both the application recognition classifier and the intrusion detection classifier. In still more embodiments, the trained MTL model may be deployed on the network device, such as the AP or any other edge-based network device, for network traffic classification.

Thus, the edge-based packet processing for application recognition and intrusion detection may offer significant advantages, such as unified packet representation that simultaneously enhances application recognition and intrusion detection. The diverse packet structures and encrypted traffic are addressed by leveraging advanced encoding techniques and analyzing metadata and contextual patterns without requiring decryption keys. By enabling real-time processing directly at APs and other edge-based devices, the edge-based packet processing for application recognition and intrusion detection minimizes latency, reduces data loss risks, and ensures timely threat detection. Further, the framework is adaptive and scalable, dynamically adjusting to varying network conditions and traffic patterns while reducing false positives and negatives through multi-dimensional learning and feedback integration. Thus, the holistic approach provides a comprehensive understanding of network traffic, improving security, performance, and overall network integrity.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

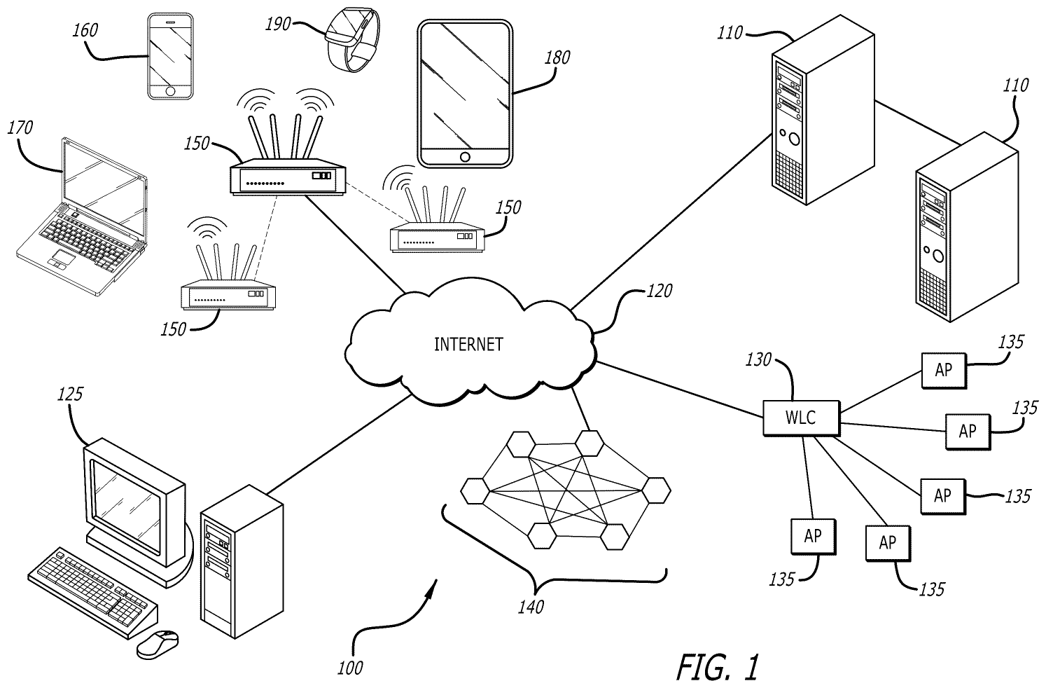

Referring to FIG. 1, a conceptual network diagram 100 of various environments in which a packet inspection logic may operate in accordance with various embodiments of the disclosure is shown. Those skilled in the art will recognize that the packet inspection logic can include various hardware and/or software deployments and can be configured in a variety of ways. In many embodiments, the packet inspection logic can be configured as a standalone device, exist as a logic in another network device or an edge-based network device or distributed among various network devices operating in tandem, or be remotely operated as part of a cloud-based network management tool to train a multi-task learning model comprising a first classifier for application recognition and a second classifier for intrusion detection. In further embodiments, one or more servers 110 can be configured with the packet inspection logic or can otherwise operate as the packet inspection logic. In many embodiments, the packet inspection logic may operate on one or more servers 110 connected to a communication network 120 (shown as the “Internet”). The communication network 120 can include wired networks or wireless networks. The packet inspection logic can be provided as a cloud-based service that can service remote networks, such as, but not limited to a deployed network 140, to train the multi-task learning model comprising a first classifier for application recognition and a second classifier for intrusion detection on packet data received by the deployed network.

However, in additional embodiments, the packet inspection logic may be operated as a distributed logic across multiple network devices. In the embodiment depicted in FIG. 1, a plurality of network APs 150 can operate as the packet inspection logic in a distributed manner or may have one specific device operate as the networking logic for all of the neighboring or sibling network APs 150. The network APs 150 may facilitate Wi-Fi connections for various electronic devices, such as but not limited to, mobile computing devices including laptop computers 170, cellular phones 160, portable tablet computers 180, and wearable computing devices 190. The APs may further process packet data received for training the multi-task learning model.

In further embodiments, the packet inspection logic may be integrated within another network device. In the embodiment depicted in FIG. 1, a wireless LAN controller (WLC) 130 may have an integrated packet inspection logic that the WLC 130 can use to train the multi-task learning model comprising a first classifier for application recognition and a second classifier for intrusion detection on packets processed by the APs 135 that the WLC 130 is connected to, either wired or wirelessly. In still more embodiments, a personal computer 125 may be utilized to access and/or manage various aspects of the packet inspection logic, either remotely or within the network itself. In the embodiment depicted in FIG. 1, the personal computer 125 communicates over the communication network 120 and can access the packet inspection logic of the one or more servers 110, the network APs 150, or the WLC 130. In still more embodiments, the packet inspection logic may be integrated into laptop computers 170, cellular phones 160, portable tablet computers 180, and wearable computing devices 190 to collect packet data received by the laptop computers 170, cellular phones 160, portable tablet computers 180, and wearable computing devices 190. In still further embodiments, the processed packet data and the trained multi-task learning model may be utilized by a packet inspection logic integrated and deployed in the network APs 150 or edged-based network devices located at the “edge” of the network.

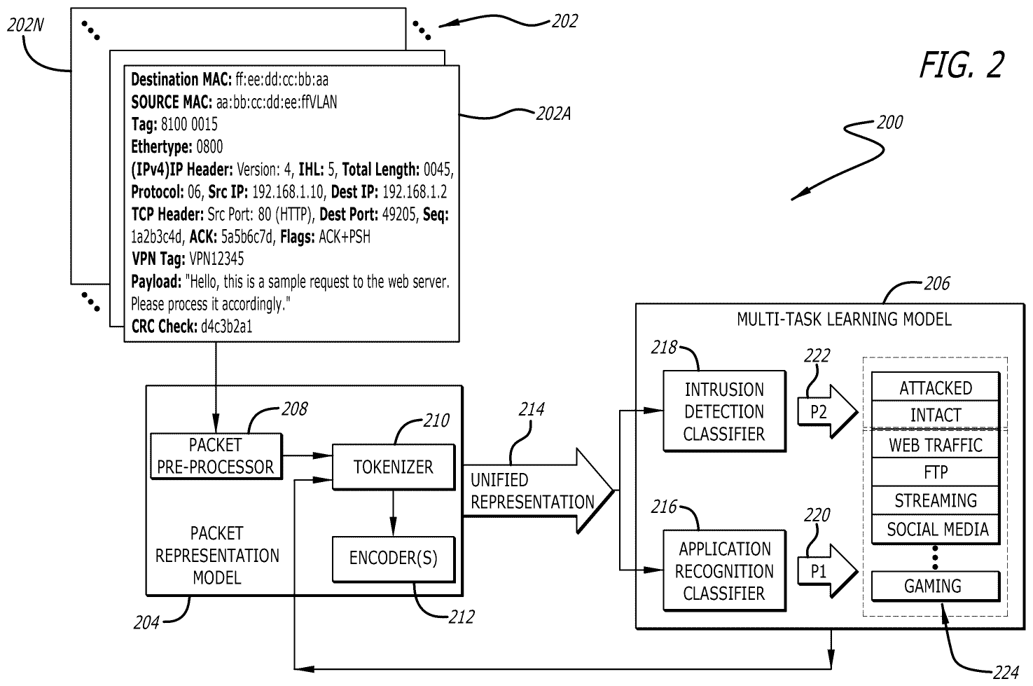

Although a specific embodiment for various environments that the packet inspection logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the packet inspection logic may be provided as a device or software separate from the WLC 130, or the packet inspection logic may be integrated into the WLC 130 or the network APs 150. The elements depicted in FIG. 1 may also be interchangeable with other elements of FIGS. 2-12 as required to realize a particularly desired embodiment.

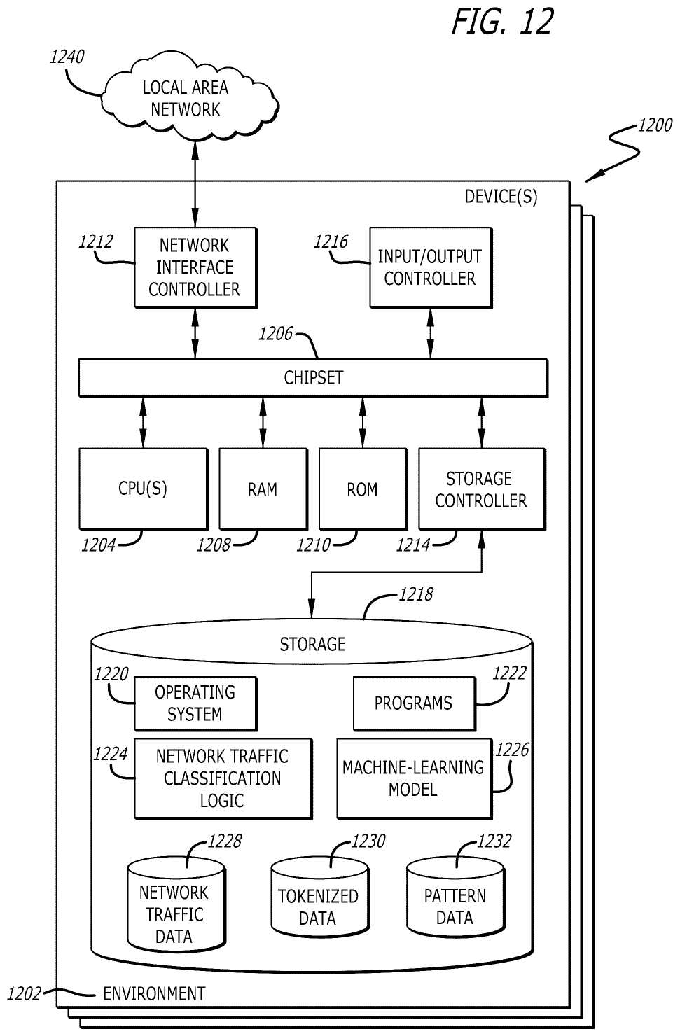

Referring to FIG. 2, a conceptual block diagram of a network traffic classification framework 200 in accordance with various embodiments of the disclosure is shown. The embodiments shown in FIG. 2 may illustrate a scenario where the network traffic classification framework 200 is implemented on an edged-based network device, enabling edge-based packet processing for application recognition and intrusion detection. In a non-limiting example, it is assumed that the edged-based network device is equipped with requisite hardware and software infrastructure to implement the network traffic classification framework 200 for packet processing. The edge-based network device may also run a software stack that supports the network traffic classification framework 200 to classify network traffic in real time or near real time. Additionally, the edge-based network device may integrate with higher-level systems, such as network administration tools, intrusion prevention systems, or other deep packet inspection systems. Examples of the edged-based network device may include an access point, an edge router, a switch, a network interface card, a load balancer, a firewall device, a gateway, an Internet of Things (IoT) device, or the like. An example of the edged-based network device is described later in conjunction with FIG. 12.

In the embodiment depicted in FIG. 2, the edge-based network device may include a packet inspection logic configured to implement the network traffic classification framework 200. The packet inspection logic can include various hardware and/or software deployments and can be configured in a variety of ways. For example, the packet inspection logic can be a set of instructions stored within a non-volatile memory that, when executed by a processor(s) can carry out the steps for network data analysis. For the sake of ongoing description, operations performed by the packet inspection logic are considered as performed by the edge-based network device as the packet inspection logic is included in or integrated with the edge-based network device.

In an example embodiment shown in FIG. 2, the edge-based network device may receive network traffic 202 including a series of packets 202A-202N. A packet may refer to a fundamental unit of data transmission in a network, carrying information between devices over the Internet or local networks. The series of packets 202A-202N may be unfiltered, raw data that may be received at the edge-based network device. When received at the edge-based network device, the series of packets 202A-202N may be processed to ensure proper routing, analysis, and delivery to their intended destination. Each packet in the series of packets 202A-202N has a structured format, typically comprising one or more headers, a payload, and a trailer. The header(s) may include metadata such as source and destination IP addresses, protocol type, source and destination ports, and packet sequence information, enabling the edge-based network device to understand from where the network traffic 202 is received and where the network traffic 202 needs to be transmitted. The payload may correspond to the actual data being transmitted, such as a file segment, a message, or a media stream. In some embodiments, the payload may be encrypted for security. In some more embodiments, the payload can be plaintext. The trailer, if present, may include error-checking information to ensure data integrity during transmission. With reference to a video streaming example scenario, the series of packets 202A-202N may include metadata specifying a codec type in the header(s), while the payload may carry fragments of video data. The edge-based network device may be configured to process the series of packets 202A-202N to ensure uninterrupted streaming, potentially analyzing them for performance optimization or security checks.

In a number of embodiments, the network traffic classification framework 200 shown in FIG. 2 may include two models such as a packet representation model 204 and a multi-task learning (MTL) model 206. In a non-limiting example, the packet representation model 204 may be configured to transform each raw network packet (such as the series of packets 202A-202N) into a structured, machine-readable format by parsing the packet into meaningful components, such as tokens, and encoding the tokens into representations using specialized techniques tailored for plaintext and encrypted data. On the other hand, the MTL model 206 may be configured to utilize the encoded representations to simultaneously address multiple tasks, such as application recognition and intrusion detection. The functionalities of the packet representation model 204 and the MTL model 206 are described in greater detail in the following description.

In a variety of embodiments, the packet representation model 204 may receive the series of packets 202A-202N for processing. For the sake of brevity, functions of the packet representation model 204 and the MTL model 206 are described with reference to the packet 202A. It will be apparent that the packet representation model 204 and the MTL model 206 may process remaining packets in the series of packets 202A-202N in a similar manner. The packet representation model 204 may include a packet pre-processor 208, a tokenizer 210, and one or more encoders 212 (hereinafter referred to as “encoder(s) 212”) that may be configured to transform the packet 202A into a structured, machine-readable format such as a unified representation.

In various embodiments, the packet 202A may include one or more headers and a payload. The payload can be encrypted or plaintext. Upon receiving the packet 202A, the packet pre-processor 208 may be configured to process the packet 202A for further analysis. During processing, the packet pre-processor 208 may extract, organize, and standardize packet data of the packet 202A. In an example scenario, initially, the packet 202A may be in the form of a binary stream. The packet pre-processor 208 may parse the binary stream to extract relevant fields. For example, the packet pre-processor 208 may parse the packet 202A to separate different fields of the packet 202A such as the header(s) and the payload. Once the packet 202A is parsed, the packet pre-processor 208 may standardize the parsed fields, for example, by converting the parsed information into a more consistent format. Standardization may involve converting IP addresses to a uniform textual representation (e.g., converting an IP address from its binary form to a standard IPv4 dotted-decimal format), normalizing timestamps, standardizing byte order, or the like. Standardization may also include removing redundant or unnecessary data and structuring the parsed fields into predefined schemas (e.g., JSON or XML), which can then be forwarded to the tokenizer 210. In other words, the packet pre-processor 208 may extract a set of features, such as internet protocol (IP) addresses, ports, and protocol types, from the packet 202A, and standardize the extracted set of features for downstream processing.

In a variety of embodiments, the edge-based network device may then forward the processed packet 202A from the packet pre-processor 208 to the tokenizer 210, which may further refine the processed packet 202A and generate a sequence of tokens. In other words, the tokenizer 210 may further parse the processed packet 202A into smaller, meaningful units, such as “tokens,” which can be individually analyzed. Different tokenization strategies may be applied to different features or components of the processed packet 202A. In one or more embodiments, the tokenizer 210 may apply various tokenization strategies to generate the sequence of tokens.

In an example scenario, the tokenizer 210 may utilize a natural language processing-based scheme on the processed packet 202A to generate the sequence of tokens. In the natural language processing-based scheme, the tokenizer 210 may observe packet data of the processed packet 202A as natural language text, where the header(s) and plaintext payload are split into tokens akin to sentences and words in natural language processing. For example, the tokenizer 210 may divide the packet data into fields or key-value pairs such as “SRC=192.168.1.1”, “DST=192.167.1.10”, “PRTO=TCP”, “PLD=Hi”, similar to how sentences are split into words. Thus, the sequence of tokens may include one or more first tokens generated based on the header(s) and one or more second tokens generated based on the plaintext payload. However, in a scenario where the payload corresponds to encrypted text, the tokenizer 210 may first convert the encrypted text into one or more codes, such as hexadecimal codes, ASCII codes, base64 codes, unicode, etc., and then tokenize these one or more codes to generate the one or more second tokens. For example, the encrypted text in the payload may include binary data “01101111011001010111010001101000”. The tokenizer 210 may first convert this binary data to hexadecimal codes as “6F”, “65”, “74”, “68”, and then to the one or more second tokens such as “PLD=6F”, “PLD=65”, “PLD=74”, “PLD-68”. The one or more second tokens may then be appended to the one or more first tokens to form the sequence of tokens representing full “packet sentence”, preserving both a semantic meaning of the header(s) and a structure of the encrypted payload. For example, the tokenizer 210 may append the one or more second tokens to the one or more first tokens to form the sequence of tokens, e.g., “SRC=192.168.1.1”, “DST=192.167.1.10”, “PRTO=TCP”, “PLD-6F”, “PLD-65”, “PLD=74”, “PLD=68”.

In a further example scenario, the tokenizer 210 may utilize a fixed-length chunking scheme on the processed packet 202A to generate the sequence of tokens. In the fixed-length chunking, the tokenizer 210 may divide both the packet header(s) and the payload (encrypted or plaintext) into fixed-length chunks or blocks, irrespective of their semantic meaning. Each chunk may represent a portion of the packet data.

In a yet further example scenario, the tokenizer 210 may utilize a protocol aware tokenization scheme on the processed packet 202A to generate the sequence of tokens. In the protocol aware tokenization scheme, the tokenizer 210 may leverage a known protocol structure of the processed packet 202A and tokenize the processed packet 202A according to predefined fields in the protocol structure. For example, the header(s) may be split into the one or more first tokens based on the protocol fields, such as “SRC: 192.168.1.1”, “DST: 192.167.1.10”, and “PRTO: TCP, and the payload may be divided into the one or more second tokens based on application-layer protocols such as HTTP, or the like. For instance, for an HTTP packet, the one or more second tokens may include “Method: GET” and “Host: example.com”.

In still further example scenario, the tokenizer 210 may utilize an entropy-based segmentation scheme on the processed packet 202A to generate the sequence of tokens. In the entropy-based segmentation scheme, the tokenizer 210 may split the packet 202A into the sequence of tokens based on changes in entropy. Entropy may refer to a measure of uncertainty or randomness within the data. Low-entropy sections, such as the header(s), may include repetitive and structured data, while high-entropy sections, such as the payload, may include more random or encrypted data.

In still yet further example scenario, the tokenizer 210 may utilize a frequency-based segmentation scheme on the processed packet 202A to generate the sequence of tokens. In the frequency-based segmentation scheme, the tokenizer 210 may tokenize the packet 202A based on a frequency of specific byte patterns. The tokenizer 210 may identify frequent byte patterns in the processed packet 202A and assign them to standard tokens. Less frequent patterns, indicative of the payload, may be assigned to distinct tokens.

In additional embodiments, the edge-based network device may then forward the generated sequence of tokens from the tokenizer 210 to the encoder(s) 212. The encoder(s) 212 may be configured to generate a unified representation 214 based on the sequence of tokens. The unified representation 214 may correspond to a numerical or feature-based abstraction (e.g., encoded vectors or matrices) that is suitable for being provided as input to machine learning models. The encoder(s) 212 may utilize specialized encoding techniques to preserve the semantic and byte-level context represented by the sequence of tokens. In other words, the encoder(s) 212 may be configured to capture both semantic and byte-level patterns of the sequence of tokens, regardless of underlying protocols or formats associated with the sequence of tokens. In a non-limiting example, a first encoder in the encoder(s) 212 may encode one or more readable segments (headers tokens, plaintext payload tokens) of the sequence of tokens, while a second encoder in the encoder(s) 212 may encode encrypted text tokens of the sequence of tokens. That is to say, the first encoder enables a representation of the packet 202A as a structured sequence of fields, analogous to a sentence, while the second encoder represents the encrypted payload section of the packet 202A as a pattern, preserving its structural characteristics for further analysis. In a scenario where the packet 202A includes plaintext payload, only the first encoder may be utilized to generate the unified representation 214 based on the sequence of tokens. However, in scenarios where the packet 202A includes encrypted text as payload, the first encoder and the second encoder may be utilized to generate the unified representation 214. The first encoder may operate on the one or more first tokens and the second encoder may operate on the one or more second tokens.

In one or more embodiments, the unified representation 214 may include a first representation that indicates the semantic pattern of the packet 202A and one or more second representations that indicate a byte-level pattern of the packet 202A. A second representation of the one or more second representations may correspond to a token of the sequence of tokens. For example, the one or more second representations may have a 1:1 correspondence with the sequence of tokens.

“Semantic pattern” may correspond to functional and contextual meaning of a packet's structure, focusing on what the packet 202A represents, rather than just raw binary content of the packet 202A. For example, the packet 202A can be an HTTP request. In this example, raw data of the packet 202A may include various byte sequences representing different features or fields such as the source address, destination port, HTTP method, path, headers, or the like. The semantic pattern may refer to how these features or fields are interpreted and understood in the context of the HTTP protocol. For instance, a source address (e.g., 192.168.1.10) may signify a client initiated request, while a destination port (e.g., 80) may indicate a server's HTTP service. The HTTP method (e.g., GET) may indicate that the client is requesting data, and the path (e.g., /index.html) may specify which resource the client is requesting from the server. Additionally, the headers may provide more context about the client's environment. When observed collectively these features may form the semantic pattern of the packet 202A, providing meaning and context to the raw byte data, such as understanding the client's intent to retrieve the “index.html” page from the server. In other words, the first representation may indicate a collective context captured by the one or more first tokens and the one or more second tokens. The collective context may include a general purpose of the packet 202A (such as whether the packet is an HTTP request, an acknowledgment in a Transport Control Protocol (TCP) connection, or the like) represented as a numerical or feature-based abstraction. In other words, the first representation may integrate information from the one or more first tokens and the one or more second tokens of the packet 202A.

“Byte-level pattern” may represent low-level context associated with the packet 202A. For example, the one or more second representations may indicate specific byte-level pattern, such as raw structure of the packet 202A at a granular level. For example, the source address, destination port, HTTP method (GET), and file path (e.g., /index.html), represented as the first token(s) and the second token(s), when converted to corresponding second representations capture byte-level encoding (e.g., the exact byte sequence for the source address, the destination port, etc.). These individual second representations, when combined, form a detailed and precise description of the byte-level pattern of the packet 202A. The encoder(s) 212 may thus generate the unified representation 214 that is a structured representation of the packet 202A, combining the encoded header(s) and payload information into a format that can be efficiently processed by the MTL model 206.

In further embodiments, the edge-based network device may further provide the unified representation 214 generated by the encoder(s) 212 as an input to the MTL model 206 and the MTL model 206 may output a set of classification results for the packet 202A. In many further embodiments, the MTL model 206 may be configured to classify the unified representation 214 between two or more categories 224 for application recognition and intrusion detection and output the set of classification results. In an example shown in FIG. 2, the two or more categories 224 may include various application categories such as “Web traffic”, “FTP”, “Streaming”, “Social Media”, “Gaming”, or the like, and various intrusion status categories such as “Attacked” and “Intact”.

In yet various embodiments, the MTL model 206 may include a plurality of classifiers. The edge-based network device may thus provide the unified representation 214 as a shared input to the plurality of classifiers and obtain the set of classification results for the packet 202A as the output of the plurality of classifiers. In an example embodiment of FIG. 2, the MTL model 206 is shown to include two classifiers such as a first classifier corresponding to an application recognition classifier 216 and a second classifier corresponding to an intrusion detection classifier 218.

In still various embodiments, the application recognition classifier 216 may be configured to detect a type of application (e.g., “Web traffic”, “FTP”, “Streaming”, “Social Media”. or “Gaming) associated with the packet 202A based on the unified representation 214. The application recognition classifier 216 may generate an output P1 220 that classifies the packet 202A to one of the application categories among the two or more categories 224 based on the detection. For example, if there are five application categories “Web traffic,” “FTP,” “Streaming,” “Social Media,” and “Gaming”, the application recognition classifier 216, based on the unified representation 214, may generate probabilities indicating the likelihood of the packet 202A being associated with each application category. For instance, the probabilities can be Web traffic: 0.1, FTP: 0.1, Streaming: 0.6, Social Media: 0.5, and Gaming: 0.15. In this case, the application category with the highest probability, “Streaming”, may be identified in the output P1 220.

In yet more embodiments, the intrusion detection classifier 218 may be configured to detect whether the packet 202A is a legitimate packet or an anomalous packet based on the unified representation 214. The intrusion detection classifier 218 may generate an output P2 222 that classifies the packet 202A to one of the intrusion status categories among the two or more categories 224 based on the detection. For example, if there are two intrusion status categories “Attacked” and “Intact”, the intrusion detection classifier 218, based on the unified representation 214, may generate probabilities indicating the likelihood of the packet 202A being associated with each intrusion status category. For instance, the probabilities can be Attacked: 0.7 and Intact: 0.3. In this case, the intrusion status category with the highest probability, “Attacked”, may be identified in the output P2 222. In other words, the set of classification results may include an application recognition result, which is obtained as the output P1 220 of the first classifier (e.g., the application recognition classifier 216), indicating the application associated with the packet 202A. Further, the set of classification results may include an intrusion detection result, which is obtained as the output P2 222 of the second classifier (e.g., the intrusion detection classifier 218), indicating whether the packet 202A is a legitimate packet or an anomalous packet.

In still further embodiments, the plurality of classifiers may correspond to adaptive classifiers that re-learn based on the set of classification results. For example, the application recognition classifier 216 and the intrusion detection classifier 218 may operate in parallel but influence each other's learning process. For example, if the intrusion detection classifier 218 detects the packet 202A as “Attacked”, the application recognition classifier 216 may be inhibited from re-learning normal application pattern of the detected application category associated with the packet 202A. Conversely, if the application recognition classifier 216 identifies the packet 202A as well-known traffic belonging to one of the application categories, the application recognition classifier 216 may be configured to suppress the output P2 222 of the intrusion detection classifier 218 for the packet 202A. However, if the application recognition classifier 216 identifies the packet 202A as a new traffic with no confirmed application category, the intrusion detection classifier 218 may be triggered to analyze the packet 202A further for detecting the intrusion status category.

In many additional embodiments, this interaction between the application recognition classifier 216 and the intrusion detection classifier 218 may not be flat but can occur across multiple dimensions, where different components and features contribute to mutual refinement. The effectiveness of the MTL model 206 can be validated locally, without relying on external processing, using synthetic traffic, for example, to test its adaptive learning. The learner adjusts dynamically, with linear improvement in identifying new traffic patterns and a direct correlation between variations in synthetic traffic and system convergence. This adaptive multidimensional interaction may enhance both application recognition and intrusion detection.

In still more embodiments, the MTL model 206 may be configured to propagate feedback from the plurality of classifiers (e.g., the application recognition classifier 216 and the intrusion detection classifier 218) to the encoder(s) 212 and tune at least one parameter of the encoder(s) 212 based on the propagated feedback. In an example embodiment, the tuning of the parameter(s) of the encoder(s) 212 may be based on gradient information derived from the propagated feedback. For example, in the context of application recognition and intrusion detection, the application recognition classifier 216 and the intrusion detection classifier 218 may generate gradients during backpropagation (e.g., feedback) that indicate how the unified representation 214 of the encoder(s) 212 affected their classification accuracy. Additionally, the feedback may allow the encoder(s) 212 to adaptively emphasize those features that are more relevant for application recognition and intrusion detection. For instance, in a scenario where the feedback indicates that application recognition relies on packet duration (or length) while intrusion detection depends on inter-arrival time of packets, the encoder(s) 212 may learn to allocate representational capacity, prioritizing temporal features over other features during the encoding of subsequent unified representations.

Accordingly, the feedback loop between the MTL model 206 and the packet representation model 204 may ensure that the encoder(s) 212 adapt representation encoding to generate subsequent unified representations based on the performance of the plurality of classifiers (e.g., the application recognition classifier 216 and the intrusion detection classifier 218). For example, if one or more patterns (byte-level pattern or semantic pattern) in the unified representation 214 led to the misclassification of the packet 202A, the feedback can adjust one or more weights of the encoder(s) and/or the tokenizer 210 to capture relevant patterns in subsequent unified representations. Thus, the tuning may optimize the classification process for each task (e.g., application recognition and intrusion detection) individually and also enhance the overall analysis by drawing on the synergies between multiple tasks (e.g., application recognition and intrusion detection).

In still further embodiments, the edge-based network device may be further configured to generate one or more context-aware alerts based on the set of classification results. The one or more context-aware alerts may provide actionable insights based on the detected context of the set of classification results, such as identifying malicious activity, unusual traffic patterns, or specific application usage. By incorporating contextual information from the set of classification results, the one or more context-aware alerts can prioritize important issues, reduce false positives, and provide meaningful details to enhance decision-making for security and network management. Such one or more context-aware alerts can be provided to the higher-level systems, such as the network administration tools, the intrusion prevention systems, or other deep packet inspection systems, allowing them to take appropriate action.

Thus, as the series of packets 202A-202N in the network traffic 202 traverse the abovementioned stages (such as tokenization, representation encoding, and classification) of the network traffic classification framework 200, the edge-based network device is able to identify an application responsible for the network traffic 202. Simultaneously, due to structural parsing (tokenization and representation encoding) of each of the series of packets 202A-202N, the edge-based network device may determine whether the series of packets 202A-202N adhere to known patterns associated with the identified application. If a deviation from the expected pattern is detected, the edge-based network device may detect and flag the anomaly as a context aware alert. In an example, a context aware alert can be “A client station ABC is sending what appears to be Webex® audio, but every fifth packet is unusually longer and contains non-Webex data”.

Although a specific embodiment for a network traffic classification framework 200 suitable for carrying out the various steps, processes, methods, and operations described herein is discussed with respect to FIG. 2, any of a variety of systems and/or processes may be utilized in accordance with embodiments of the disclosure. For example, the network traffic classification framework 200 may be deployed on the edge-based network device, once the network traffic classification framework 200 has been trained, tuned, and subjected to one or more machine learning methodologies. The elements depicted in FIG. 2 may also be interchangeable with other elements of FIGS. 1, 3-12 as required to realize a particularly desired embodiment.

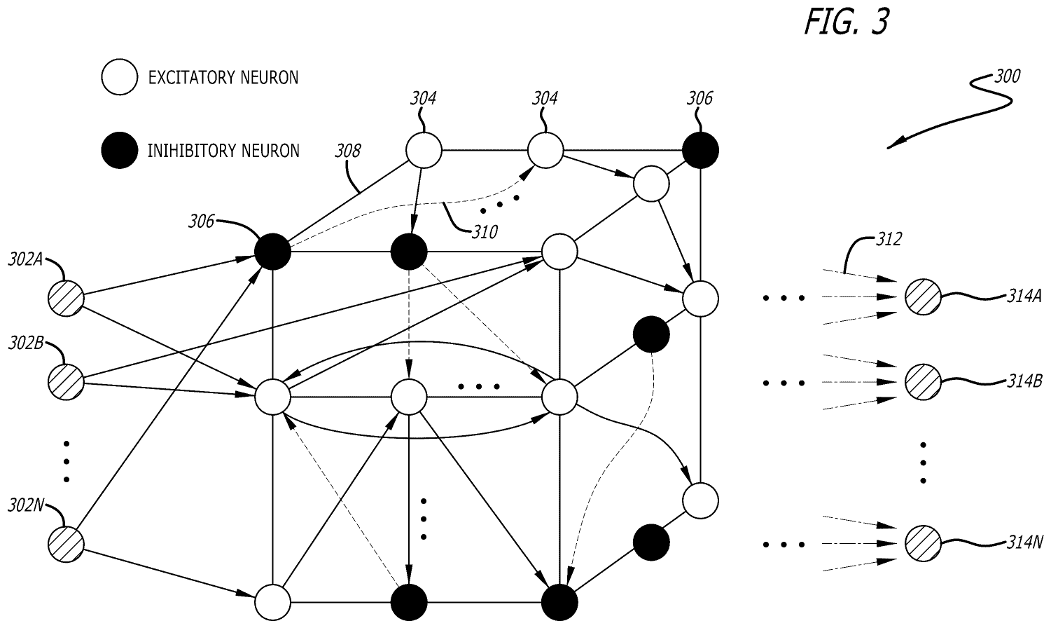

Referring to FIG. 3, a diagram that illustrates a liquid neural network 300 utilized in edge-based packet processing for application recognition and intrusion detection in accordance with various embodiments of the disclosure is shown. The term “liquid” may emphasize the adaptability and fluidity of the liquid neural network 300, as the liquid neural network 300 may be configured to adjust its structure dynamically in response to learning tasks and varying network states. Unlike rigid, static models, the liquid neural network 300 may interconnect neurons through dynamic synapses to facilitate multi-task learning (MTL) by sharing information across tasks and adapting activation states accordingly.

In a number of embodiments, the liquid neural network 300 may be utilized to train an MTL model (for example, the MTL model 206 shown in FIG. 2). For example, a first part of the MTL model may process Task 1 (for example, an application recognition classifier that may generate an application recognition output), while a second part of the MTL model may handle Task 2 (for example, an intrusion detection classifier that may generate an intrusion detection output). The two tasks may influence each other via excitatory and inhibitory mechanisms. The liquid neural network 300 may receive a shared subset of inputs 302A, 302B-302N (e.g., unified representations indicating synaptic and byte-level patterns of network packets) that both tasks Task 1 and Task 2 utilize, and each task may also have its own task-specific inputs. The liquid neural network 300 may receive the shared subset of inputs 302A-302N that may be provided to at least two primary types of neurons of the liquid neural network 300, for example, a plurality of excitatory neurons 304 and a plurality of inhibitory neurons 306, via a plurality of synapses that may be excitatory synapses 308 that amplify signals or inhibitory synapses 310 that suppress signals. The output of Task 1 may be used as input for a next learning phase of Task 2. That is to say, an application recognition output generated by the application recognition classifier may act as one of an excitatory influence or an inhibitory influence on the second part, for example, the intrusion detection classifier. Similarly, the intrusion detection output from the intrusion detection classifier may act as one of an excitatory influence or an inhibitory influence on the first part, e.g., the application recognition classifier. In other words, the shared subset of inputs 302A-302N may be input neurons that may be connected through sparse random synapses. The sparse random synapses may be found between the shared subset of inputs 302A-302N (e.g., input neurons), the plurality of excitatory neurons 304, and the plurality of inhibitory neurons 306. The sparse random synapses may create a flexible, recurrent structure, allowing diverse patterns of interaction and feedback loops.

In a variety of embodiments, the shared subset of inputs 302A-302N may be connected to the plurality of excitatory neurons 304 via the excitatory synapses 308. The excitatory synapses 308 may amplify signals to activate the plurality of excitatory neurons 304 for further learning. That is to say, if the output of Task 1 is close to 1, it may indicate that Task 1 is activated or “excited.” The output of Task 1 can strongly influence the next phase of learning in the Task 2 of the MTL model. For example, if Task 1 identifies traffic as well-known, the excitatory synapses 308 may enhance Task 2's ability to confirm it as non-malicious.

In more embodiments, the shared subset of inputs 302A-302N may be connected to the plurality of inhibitory neurons 306 via the inhibitory synapses 310 that may suppress signals to prevent redundant or incorrect learning. That is to say, if the output of Task 2 is close to 0, it may be considered “deactivated” or “inhibited.” This means that the output from Task 2 may have minimal influence on the next phase of learning. For example, if Task 2 identifies traffic as malicious, it might inhibit Task 1 from learning it as a normal application flow.

In further embodiments, the output of the plurality of excitatory neurons 304 and the plurality of inhibitory neurons 306 may be connected to a plurality of output neurons 314A, 314B-314N through dense trainable synapses 312 that may be responsible for generating precise, task-specific outputs. For example, Task 1 (e.g., application recognition) may identify a flow as “streaming traffic” with high confidence. This information may excite Task 2 (e.g., intrusion detection), reducing its likelihood of flagging the traffic as malicious. Conversely, if Task 2 detects unusual packet density in the same flow, it inhibits Task 1 from classifying it as normal streaming traffic. This iterative interaction may ensure both tasks refine their outputs, leveraging shared insights for better decision-making. Further, outputs from these tasks are fed back to each other in a fluid, interactive manner. The liquid neural network 300 dynamically adjusts the influence between tasks, allowing one task to potentially excite or inhibit the learning process of the other task.

In additional embodiments, the liquid neural network 300 may be trained by providing synthetic traffic to mimic a new application and is interleaved with well-known traffic before being introduced into the liquid neural network 300. Initially, this synthetic traffic may be detected or flagged as suspicious or unknown with a high probability. However, as more of the synthetic traffic is injected, the probability of the synthetic traffic being flagged as malicious or unknown decreases linearly. Once the traffic is fully learned and no longer reported as malicious, variations are introduced into the synthetic traffic pattern, such as changes in payload length or packet density over time. The liquid neural network 300 may then compute correlations between these deviations and the outputs of both the intrusion detection and the application recognition classifiers. In numerous embodiments, the liquid neural network 300 may be configured to dynamically adjust based on the traffic received. Accordingly, the application recognition classifier may improve its identification of the synthetic traffic at the same rate as the ID classifier may reduce its malicious flags.

Although a specific embodiment for a liquid neural network utilized in edge-based packet processing for application recognition and intrusion detection suitable for carrying out the various steps, processes, methods, and operations described herein is discussed with respect to FIG. 3, any of a variety of systems and/or processes may be utilized in accordance with embodiments of the disclosure. For example, other neural networks apart from liquid neural network architecture (e.g., Recurrent Neural Networks “RNNs”, Long Short-Term Memory Networks “LSTMs”, Gated Recurrent Units “GRUs”, Neural Turing Machines “NTM”, Transformers with dynamic attention, Self-Organizing Maps “SMO”, and Neural Architecture Search “NSA” models) may be utilized for training the MTL model. The elements depicted in FIG. 3 may also be interchangeable with other elements of FIGS. 1-2 and 4-12 as required to realize a particularly desired embodiment.

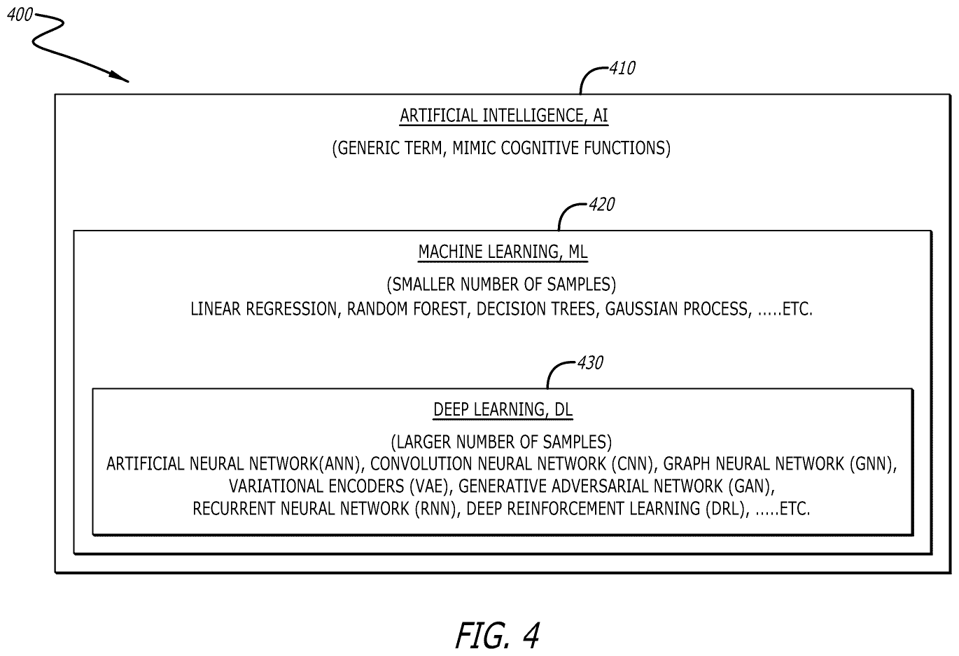

Referring to FIG. 4, a diagram 400 depicting various subsets of artificial intelligence in accordance with various embodiments of the disclosure is shown. Artificial intelligence (AI) 410 is typically understood in the art to be the development of machines and algorithms that mimic human intelligence, for example, by optimizing actions to achieve certain goals. At its core, AI 410 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 410 can be considered a generic term because it encompasses a wide range of subfields and techniques, from simple rule-based systems to advanced machine learning and deep learning models. These AI techniques are used to simulate various aspects of human cognition. For example, machine learning (ML) 420 allows computers to learn from data patterns without explicit programming for each task, while natural language processing (NLP) enables machines to understand and generate human language. Deep learning (DL) 430, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 410 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 420 is a subset of AI 410 that focuses on the development of algorithms and statistical models that enable computers to learn and make decisions from data without explicit programming. In traditional programming, a computer is given a fixed set of rules to follow, but ML 420 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to classify a packet, received at a network device in a network, between two or more categories for application recognition and intrusion detection. The network device may include any edge-based network device, such as an AP, an edge router, a switch, a network interface card, a load balancer, a firewall device, a gateway, an IoT device, or the like that handles data transmission in the network.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 420. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical network packet data, tokens, encoded data, representation data, or classification data associated with a set of classification results of a network packet received by a network device.

However, traditional ML methods rely heavily on feature engineering, wherein human experts manually identify the most relevant features or patterns within the data. For example, when using ML 420 for application recognition in a network packet, an expert might need to extract features like source, destination, and protocol information before feeding them into a model. This requirement can limit the scalability of traditional ML approaches, especially when dealing with large, unstructured datasets such as network packet data and the diverse nature of each network packet. Additionally, ML algorithms may often work best when provided with relatively structured data, and they often need a reasonable number of samples (typically more than 100) to learn effectively.

DL 430 is a specialized subset of ML 420 that employs multi-layered artificial neural networks to automatically learn complex patterns and representations from large, often unstructured datasets. Inspired by the way the human brain processes information, DL 430 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 430 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like predicting a power surge event and taking corrective measures pre-emptively.

Artificial Neural networks (ANNs or sometimes just NNs) are often a foundation of a DL system. The basic unit of a neural network is typically the perceptron, which can take inputs, assign weights to these inputs, and combine them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 420 neural network designed to work particularly well with network traffic data, making them highly relevant for edge-based packet processing functions for application recognition and intrusion detection. As those skilled in the art will recognize, CNNs typically use specialized layers known as convolutional layers, which apply filters (also known as kernels) to the input data. These filters slide over the input (e.g., packet data), detecting patterns like surges or dips, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as a network packet is for a particular application or is legitimate or malicious.

While CNNs are well-suited for grid-based data. Many real-world problems can involve non-grid data, such as network packets. This type of data can be better represented as a graph, where nodes represent entities within the packet (e.g., headers, payload, or specific fields like source and destination IPs), and edges represent relationships between these entities (e.g., protocol dependencies, flow characteristics, or hierarchical structure). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is important in predicting properties that depend on the current/local structure, such as classifying a packet data as malicious or legitimate and further identifying an application linked with the packet.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to generate a unified representation of unstructured packet data to classify the unified representation into an application recognition category and an intrusion status category.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to generate synthetic network traffic to manufacture a new traffic pattern supposed to represent a new application such that a network traffic pattern is fully learned and stops being reported as malicious/unknown.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as complex network traffic simulations.

In network traffic classification in edge-based network devices, DRL can be used in scenarios where an optimal decision needs to be made, such as optimally classifying a packet into one application category while also classifying the packet as one of legitimate or anomalous. The combination of RL and DL can allow for learning from raw data, making it a powerful tool for dynamic and real-time network traffic classification in the network device.

Although a specific embodiment for a diagram 400 depicting various subsets of artificial intelligence suitable for carrying out the various steps, processes, methods, and operations described herein is discussed with respect to FIG. 4, any of a variety of systems and/or processes may be utilized in accordance with embodiments of the disclosure. For example, other subset may be present and available for use within AI 410. Those skilled in the art will recognize that the diagram 400 presented in FIG. 4 is simplified for illustration purposes and various methods and techniques may interact with other areas (ML 420 with DL 430, etc.). The elements depicted in FIG. 4 may also be interchangeable with other elements of FIGS. 1-3 and 5-12 as required to realize a particularly desired embodiment.

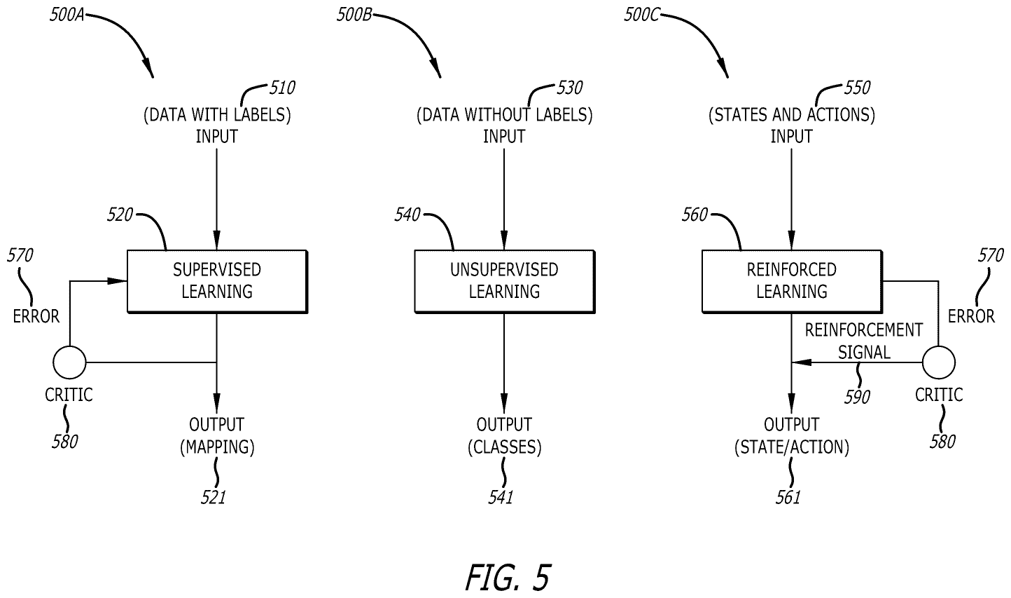

Referring to FIG. 5, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories: classification and regression. Likewise, unsupervised learning can be divided into three categories: clustering, association rule, and/or dimensionality reduction.

In the embodiment depicted in FIG. 5, a supervised learning system 500A is shown. The supervised learning system 500A can be configured with a supervised learning model 520 that accepts input data 510 and generates an output 521. However, the output data is often reviewed by a critic 580 that can determine one or more errors 570 that are fed back into the supervised learning model 520 for use in updating.

Supervised learning systems 500A are often considered the simplest machine learning model to understand in which input data (such as training data) has a known label or result as an output. So, the supervised learning model 520 can be understood to work on the principle of input-output pairs. As such, a function can be trained using a training data set, which is then applied to unknown data and makes some predictive performance. Supervised learning is task-based and mostly tested on labeled data sets.

Supervised learning systems 500A may often involve one or more regression problems. In regression problems, the output is a continuous variable. Some commonly used Regression models include linear regression, decision trees, and random forests. Linear regression is typically the most straightforward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to classifying network traffic data into two or more categories for application recognition and intrusion detection. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can analyze a unified representation of at least one packet and produce a set of classification results. The classification results may include various labels, for example, a type of application “streaming application” associated with the packet and an intrusion status (e.g., “Attacked”, “Intact”, etc.,) of the packet. The results help in making real-time decisions, such as prioritizing legitimate packets or blocking malicious packets. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, surge/dip, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if data in the network need to be classified based as packets (structured data units for transmission), frames (data link layer sequences with headers and payloads), IP addresses (numerical network identifiers), and MAC addresses (hardware identifiers). So, a data type having a packet, discovery frame, IP address, and MAC address will be recognized as a data packet sent for discovering a destination device with a specific MAC address in a specific IP network. Here each feature is independent of other features. Likewise, various embodiments herein can classify packets based on packet data, token data, encoded data, representation data, classification data, etc.

Again, in the embodiment depicted in FIG. 5, an unsupervised learning system 500B is shown. The unsupervised learning system 500B can be configured with an unsupervised learning model 540 that accepts input data 530 and generates an output 541. Unlike other model types, there are no critics or error signals to process. Unsupervised learning models 540 can implement the learning process opposite to supervised learning, which means it enables the model to learn from an unlabeled training dataset. Based on the unlabeled dataset, the unsupervised learning model 540 can predict the output. Using an unsupervised learning system 500B, the unsupervised learning model 540 can learn hidden patterns from the dataset by itself without any supervision. In various embodiments, unsupervised learning models 540 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to classify packets between two or more categories for application recognition and intrusion detection. This algorithm can be applied in packet analysis, market web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 5, a reinforcement learning system 500C is shown. The reinforcement learning system 500C can be configured with a reinforcement learning model 560 that accepts input data 550 and generates an output 561. In reinforcement learning, the reinforcement learning model 560 learns actions for a given set of states that lead to a goal state. In the embodiment depicted in FIG. 5, a critic 580 can receive or otherwise notice error(s) 570 within the reinforcement learning model 560 actions, and adjust the outcome/output by way of a reinforcement signal 590 such that the “reward” or “punishment” is adjusted to better model the future behaviors or processing of the reinforcement learning model 560.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 5, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 5 may also be interchangeable with other elements of FIGS. 1-4 and 6-12 as required to realize a particularly desired embodiment.

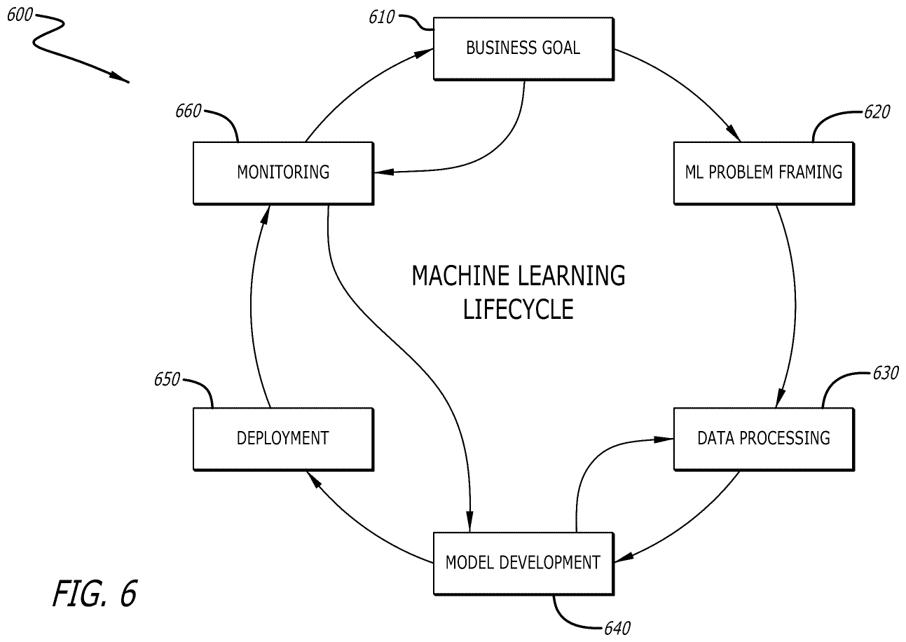

Referring to FIG. 6, a machine learning (ML) lifecycle 600 in accordance with various embodiments of the disclosure is shown. During the development of machine learning systems, the embodiment depicted in FIG. 6 can provide a framework for how to structure the design and maintenance of these systems. This ML lifecycle 600 outlines various stages involved in building, deploying, and improving ML models to solve real-world problems. By following this structured process, businesses and organizations can ensure that their machine learning projects align with strategic goals, use data effectively, and adapt to changing conditions over time. This ML lifecycle 600 emphasizes that developing a machine learning model is not a one-time effort but an iterative process requiring ongoing monitoring and adjustment. The feedback loop inherent in the ML lifecycle 600 allows for continual refinement and optimization of models to maintain their accuracy and relevance.

In many embodiments, a first stage of the ML lifecycle 600 is identifying the business goal 610, which sets the overall direction and purpose of the ML project. This can involve understanding the specific problems or opportunities within the business or project that machine learning can address. A clear business goal 610 ensures that the project remains focused on delivering tangible value, whether it is analyzing packet data, a tokenizing event, an encoding event, or a classification event of packet data. Without a well-defined goal, it can be challenging to align the subsequent stages of the ML lifecycle 600, as the choice of model, data processing methods, and performance metrics can all depend on what the business aims to achieve.

Establishing a proper business goal 610 can also involve engaging with key stakeholders and developers to gather requirements and set success criteria. It can provide a roadmap that outlines what success looks like and helps in framing the ML problem. For example, if the goal is to classify network traffic, the project might focus on building a predictive model that identifies potential bottlenecks, allowing the packet inspection controller to intervene proactively. Clearly defined goals not only help guide the project but also provide benchmarks for evaluating the effectiveness of the deployed model once it enters production.

Once the business goal 610 is established, various embodiments take a next step involving ML problem framing 620, wherein the goal is translated into a specific machine learning task. This can involve selecting the appropriate type of ML problem, such as classification, regression, clustering, or recommendation, and defining the target variables or outputs. For example, if the goal is to detect intrusion events and application categories locally at edge-based network devices, the problem can be framed as a binary classification task, where the model predicts whether a given representation encoding will generate accurate classification results. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 630 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 630 can require or at least benefit from careful planning and iterative refinement. Once the data is processed, it is typically split into training, validation, and test sets to develop and evaluate the model, ensuring that it generalizes well to new, unseen data.

Model development 640 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 640, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 630.

In further embodiments, deployment 650 is the stage where the developed model is integrated into the production environment to perform its intended tasks. This phase may involve setting up the necessary infrastructure, such as APIs or cloud-based services, to allow the model(s) to process live data and generate predictions. Deployment 650 can transform the model from a research tool into a functional component of a business process or product, providing real-time insights, automations, or decisions.

Proper deployment 650 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 610.

In more embodiments, monitoring 660 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 660, teams can identify when the model's performance drops and requires retraining or adjustments to align with the evolving data.

Monitoring 660 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 630 and model development 640, to refine the model(s) as needed. This iterative process allows the machine learning system to adapt and maintain its alignment with the original business goal 610 over time.

Although a specific embodiment for an ML lifecycle 600 suitable for carrying out the various steps, processes, methods, and operations described herein is discussed with respect to FIG. 6, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 6 may also be interchangeable with other elements of FIGS. 1-5 and 7-12 as required to realize a particularly desired embodiment.

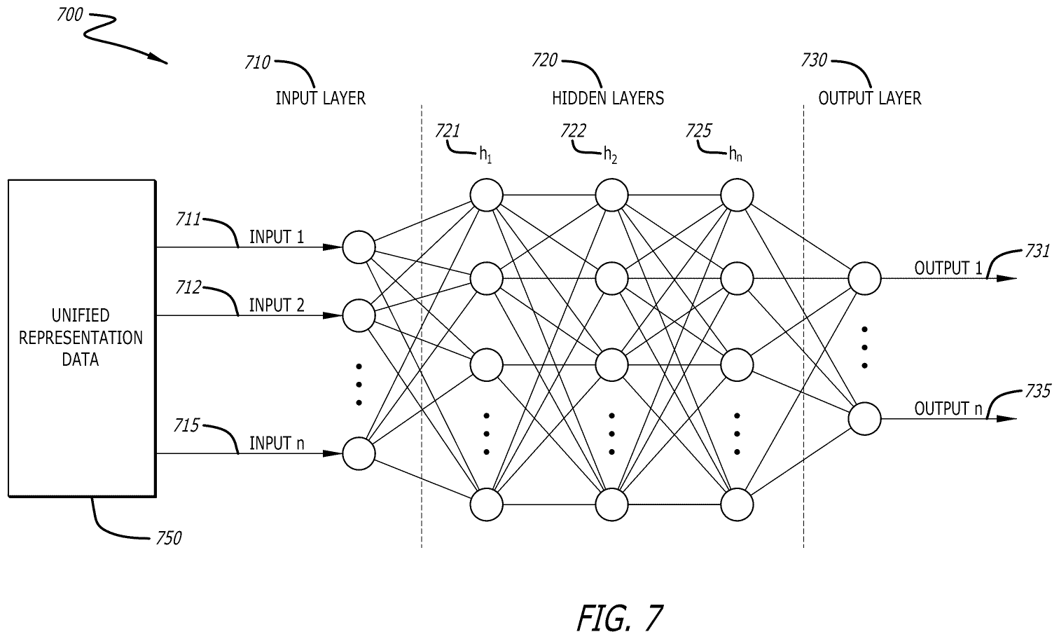

Referring to FIG. 7, an exemplary neural network 700 in accordance with various embodiments of the disclosure is shown. The embodiment depicted specifically depicts a feedforward neural network with multiple layers. This type of network consists of an input layer 710, one or more hidden layers 720, and an output layer 730. Each layer contains nodes (or neurons) that are interconnected, representing how data flows through the network. The input layer 710 can receive raw data, which is then processed by the hidden layers 720 through weighted connections and activation functions. These hidden layers 720 can enable the network to learn complex patterns and relationships within the data.

The final output layer 730 produces the network's predictions or classifications based on the processed input. The interconnected nature of the nodes allows the neural network 700 to learn from data during training by adjusting the weights of connections to minimize prediction errors. This structure is the foundation of deep learning models, as adding more hidden layers 720 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 700 depicted in the embodiment of FIG. 7, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as network traffic classification, computer vision, natural language processing, financial forecasting, and materials science. For instance, it can be employed to network traffic patterns in network devices, detect intrusion or malicious patterns in a packet, recognize an application associated with a packet, or to classify packets into different categories based on the type of packet data. It is also useful in regression problems, such as predicting classification results, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 7 is presented as an exemplary ML solution that may be deployed within one or more methods or systems described herein.

In many embodiments, the input layer 710 is the first layer in a neural network 700 and serves as the initial point where raw data is introduced into the model. Each node (or neuron) in this layer represents an individual feature or variable from the dataset, allowing the network to receive and process various types of data, such as packet data, sequence of tokens of packet data, representation data of the sequence of tokens, or classification data. For instance, in application recognition and intrusion detection tasks, the input layer can consist of nodes that correspond to shared input of unified representation obtained from an encoded sequence of tokens corresponding to packet data received at a network device, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 700 are generally scaled i.e., normalized to have a zero mean and/or unit standard deviation. Scaling can also be applied to the input of hidden layers (using batch or layer normalization) to improve the stability of neural network 700.

Unlike the hidden layers 720 and output layers 730, the input layer 710 typically does not perform any computations or transformations on the data. Its primary function is often to pass the input data to the next layer in the network, the first hidden layer 721. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in network traffic classification, the input layer may represent a sequence of tokens encoded as a unified representation of a packet, while in time-series analysis, each node might represent a data point in a sequence. While the input layer 710 itself does not modify the data, it sets the stage for the neural network to extract complex patterns and relationships through the deeper layers. This flexibility in handling various types of input make the neural network 700 a powerful tool for a diverse set of applications.

With respect to the embodiments described herein, the input layer may be configured with a plurality of inputs providing unified representation data 750. For example, a model can be configured with a first input 711 configured as a first representation indicating semantic pattern of a packet, a second input 712 is configured with a second representation indicating byte-level pattern of the packet, while additional inputs can be added related to other second representations. The nth input 715 can be configured in certain embodiments to include nth second representation indicating the byte-level pattern of the packet. However, as those skilled in the art will recognize, additional setups can be configured such that the inputs can be configured to also include different parameters of the packet, such as third representation indicating temporal pattern of the packet.

In a number of embodiments, the neural network 700 comprises a plurality of hidden layers 720. The embodiment depicted in FIG. 7 comprises a first hidden layer 721, a second hidden layer 722, and an nth hidden layer 725, which are denoted as h1, h2, and hn respectively. In many embodiments, the hidden layers 720 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 721 h1 receives direct input from the input layer, transforming the raw data into an initial set of features. For example, in a power surge detection or prediction task, this layer might begin identifying basic patterns, such as spikes or dips in the power usage patterns of the network device. The output of the first hidden layer 721 is then passed to a second hidden layer 722 h2, which builds upon the features identified by the first hidden layer 721. This deeper layer might start recognizing more complex patterns, such as shapes or specific object components, by combining the lower-level features identified earlier. This can continue on until a last, nth hidden layer 725 hn continues this abstraction process, allowing the network to recognize even higher-level, more detailed features, such as identifying a power surge event or understanding intricate relationships in the input data.

Each hidden layer adds a level of complexity and abstraction to the network's learning capabilities. The multi-layer structure can enable the network to move from recognizing simple patterns in the first input layer 721 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 730 is often the final layer in a neural network and is responsible for producing the network's predictions or classifications based on the information processed through the previous hidden layers 720. Each neuron in the output layer 730 can represent a specific outcome or category that the model can predict. In the embodiment depicted in FIG. 7, the outputs are labeled as “output 1” 731 to “output n” 735 indicating that the network can be designed to have a varying number of outputs depending on the nature of the problem being solved for. For example, in a binary classification task (e.g., detecting an intrusion vs. application recognition), there would typically be a single output neuron that provides a probability score for one of the two classes/outcomes. In contrast, for multi-class classification (e.g., categorizing a best congestion threshold value between three or more potential congestion threshold values associated with a data queue), the output layer would contain multiple neurons, each corresponding to a different class.

The number of neurons in the output layer 730 can also designed specifically for other types of tasks, such as regression, where the model can predict continuous values. In such cases, the output layer 730 might contain a single neuron representing a numerical prediction, such as the presence of malicious packet data, etc. Alternatively, in complex applications like multi-label classification (where each input can belong to multiple classes simultaneously), the output layer 730 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 700 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 7, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 7, which is an illustrative example meant to make it easier to explain the basic concepts of neural networks and how they process information. The specific features and functions described herein are not intended to be limiting to this specific embodiment. Additionally, the elements depicted in FIG. 7 may also be interchangeable with other elements of FIGS. 1-6 and 8-12 as required to realize a particularly desired embodiment.

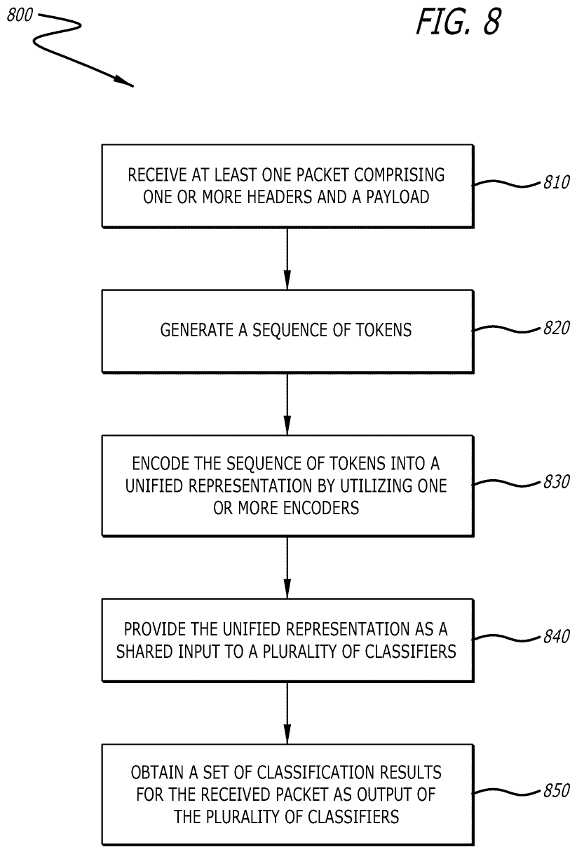

Referring to FIG. 8, a flowchart depicting a process 800 for edge-based processing of network traffic for application recognition and intrusion detection in accordance with various embodiments of the disclosure is shown. In many embodiments, the edge-based edge processing of network traffic classification may be performed at a network device (e.g., an AP, or an edge-based network device such as an edge-based server, an edge-based gateway, router, firewall, network interface card, or a network switch) associated with a network. In many embodiments, the process 800 may receive at least one packet comprising one or more headers and a payload (block 810). Hereinafter, the at least one packet may be referred to as “the packet”. The packet may be raw, unstructured network traffic data that may be pre-processed to extract key features associated with the one or more headers and the payload. The key features may include source and destination IP addresses, port numbers, protocol type, timestamps, or the like. The one or more headers of the packet may further include instructions related to the data in the packet while, the payload may include content of the packet.

In a number of embodiments, the process 800 may generate a sequence of tokens (block 820). The sequence of tokens may be generated based on the one or more headers and the payload by utilizing a tokenizer. The sequence of tokens may include one or more first tokens that may be generated based on the one or more headers. The sequence of tokens may also include one or more second tokens that may be generated based on the payload. The sequence of tokens may capture both the structural and semantic details of the packet, creating a comprehensive representation that may serve as input for further processing, such as encoding and/or classification. In various embodiments, the sequence of tokens may be generated by utilizing various tokenization schemes, for example, a natural language processing-based scheme, a fixed-length chunking scheme, a protocol aware tokenization scheme, an entropy-based segmentation scheme, or a frequency-based segmentation scheme.

In a variety of embodiments, the process 800 may encode the sequence of tokens into a unified representation by utilizing one or more encoders (block 830). The one or more encoders may be connected to the output of the tokenizer. In other words, the sequence of tokens may be encoded into the unified representation that may indicate a semantic pattern and a byte-level pattern of the received packet. That is to say, the unified representation may include a first representation indicating the semantic pattern of the received packet, and one or more second representations indicating the byte-level pattern of the received packet. Further, a second representation of the one or more second representations corresponds to a token of the sequence of tokens. For example, the one or more second representations may have a 1:1 correspondence with the sequence of tokens.

In more embodiments, the process 800 may provide the unified representation as a shared input to a plurality of classifiers (block 840). The plurality of classifiers may be associated with an MTL model and may include a first classifier and a second classifier. The first classifier of the plurality of classifiers may correspond to an application recognition classifier and the second classifier of the plurality of classifier may correspond to an intrusion detection classifier. The plurality of classifiers may further correspond to adaptive classifiers that take input from a set of classifiers among the plurality of classifiers to learn and adapt to the changes in the network traffic.

In still more embodiments, the process 800 may obtain a set of classification results for the received packet as output of the plurality of classifiers (block 850). The set of classification results may include an application recognition result obtained as an output of the application recognition classifier indicating an application associated with the received packet. The set of classification results may further include an intrusion detection result obtained as an output from the inspection detection classifier indicating whether the received packet is a legitimate packet or an anomalous packet.

Although a specific embodiment for edge-based processing of network traffic for application recognition and intrusion detection suitable for carrying out the various steps, processes, methods, and operations described herein is discussed with respect to FIG. 8, any of a variety of systems and/or processes may be utilized in accordance with embodiments of the disclosure. For example, the payload may include at least a portion of actual message content in plaintext or encrypted text. The plaintext may be directly tokenized, while encrypted text may be first converted into intermediate codes before tokenization. The elements depicted in FIG. 8 may also be interchangeable with other elements of FIGS. 1-7 and 9-12 as required to realize a particularly desired embodiment.

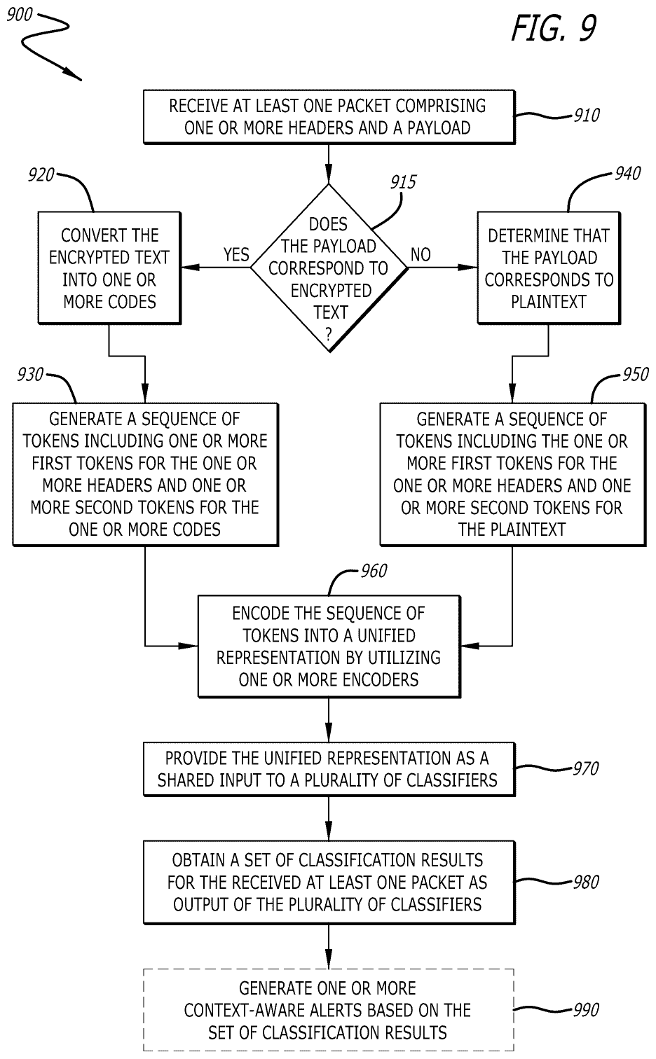

Referring to FIG. 9, a flowchart depicting a process 900 for network traffic classification in accordance with various embodiments of the disclosure is shown. The process 900 may be performed at an edge-based network device (for example, an AP) associated with a network. In many embodiments, the process 900 may receive at least one packet comprising one or more headers and a payload (block 910). The at least one packet may refer to a packet among a series of packets received by the network device. The packet can include control information and/or user data. The user data may also be referred to as payload. Control information may provide data for delivering the payload (e.g., source and destination network addresses, error detection codes, or sequencing information). The control information may be found in packet headers and trailers.

In a number of embodiments, the process 900 may determine whether the payload corresponds to encrypted text (block 915). For example, the content within the packet may be encoded using cryptographic methods to ensure confidentiality and protect the content from unauthorized access. Unlike plaintext, which can be directly read and interpreted, encrypted text may appear as a scrambled, unintelligible sequence that may require a decryption key to be understood.

Thus, if the payload corresponds to encrypted text, in a variety of embodiments, the process 900 may convert the encrypted text into one or more codes (block 920). The conversion into the one or more codes may enable the process 900 to extract patterns or features from the encrypted text without requiring the decryption key, ensuring secure and efficient analysis for tasks such as intrusion detection or application recognition. In an example, the process 900 may convert the encrypted text into Unicode, ASCII, or hexadecimal codes.

In more embodiments, the process 900 may generate a sequence of tokens including one or more first tokens for the one or more headers and one or more second tokens for the one or more codes (block 930). That is to say, the process 900 may tokenize the one or more headers to generate the one or more first tokens and the one or more codes to generate the one or more second tokens. In other words, the one or more first tokens may be generated based on the one or more headers, and the one or more second tokens may be generated based on the one or more codes of the encrypted text. The one or more second tokens may enable the encrypted text to be represented in a structured form for further encoding. The one or more second tokens may act as a reference (i.e. identifier) that may map back to the encrypted text. The one or more first tokens and the one or more second tokens may be clubbed together to generate the sequence of tokens for the packet and forwarded to one or more encoders for further processing.

However, if the payload does not correspond to encrypted text, in various embodiments, the process 900 may determine that the payload corresponds to plaintext (block 940). The one or more headers of the packet having the payload with plaintext may be converted into one or more first tokens. The payload containing the plaintext may be tokenized into one or more second tokens. In other words, the plaintext may be directly tokenized into the one or more second tokens without the need for converting the plaintext into one or more codes.

In yet more embodiments, the process 900 may generate a sequence of tokens including the one or more first tokens for the one or more headers and the one or more second tokens for the plaintext of the payload (block 950). In other words, the one or more first tokens correspond to the one or more headers of the packet while the one or more second tokens correspond to the plaintext of the payload. The one or more first tokens and the one or more second tokens may be clubbed together to generate the sequence of tokens for the packet and forwarded to the one or more encoders for further processing.

In additional embodiments, the process 900 may encode the sequence of tokens including the one or more first tokens and the one or more second tokens into a unified representation by utilizing one or more encoders (block 960). The one or more encoders may encode the sequence of tokens into the unified representation. The unified representation may indicate a semantic pattern and a byte-level pattern of the received packet. For example, the unified representation may include a first representation that indicates the semantic pattern of the packet and one or more second representations that indicate the byte-level pattern of the packet. A second representation of the one or more second representations may correspond to a token of the sequence of tokens. For example, the one or more second representations may have a 1:1 correspondence with the sequence of tokens. “Semantic pattern” may correspond to functional and contextual meaning of a packet's structure, focusing on what the packet represents within the larger network operation, rather than just its raw binary content. Thus, the first representation may integrate information from the one or more first tokens and the one or more second tokens of the packet. “Byte-level pattern” may represent low-level context associated with the packet. For example, the one or more second representations may indicate specific byte-level pattern, such as raw structure of the packet at a granular level. These individual second representations, when combined, form a detailed and precise description of the byte-level pattern of the packet.

In further embodiments, the process 900 may provide the unified representation as a shared input to a plurality of classifiers (block 970). Thus, the plurality of classifiers analyzes the same unified representation. In one or more embodiments, the plurality of classifiers may be part of an MTL model. The MTL model may be a neural network model associated with the plurality of classifiers that may be adaptive in nature such that an output from one classifier becomes an input to a learning phase of another classifier. In other words, the plurality of classifiers may be affected in the changes associated with each other and may adapt accordingly. Among the plurality of classifiers, a first classifier may be designed to function as an application recognition classifier, while a second classifier may serve as an intrusion detection classifier.

In still further embodiments, the process 900 may obtain a set of classification results for the received at least one packet as output of the plurality of classifiers (block 980). The set of classification results may include an application recognition result and an intrusion detection result. The application recognition result may be obtained as an output of the application recognition classifier indicating an application (or an application category) associated with the received packet. The intrusion detection result may be obtained as an output from the inspection detection classifier indicating whether the received packet is a legitimate packet or an anomalous packet. Since the plurality of classifiers are interconnected, the output of one classifier may affect another classifier. As such, the plurality of classifiers can adapt to any kind of changes in the network. Further, the unified representation is provided as the shared input to the plurality of classifiers to ensure that all classifiers analyze the same unified representation.

In several more embodiments, the process 900 may generate one or more context-aware alerts based on the set of classification results (block 990). The one or more contextual alerts may be tailored to provide actionable insights based on the detected context in the set of classification results, such as identifying malicious activity, unusual traffic patterns, or specific application usage. In other words, the one or more context-aware alerts may be generated to notify users or systems of specific findings, such as potential security threats or application activity. In some embodiments, the generation of the one or more context-aware alerts may be optional.

Although a specific embodiment for network traffic classification suitable for carrying out the various steps, processes, methods, and operations described herein is discussed with respect to FIG. 9, any of a variety of systems and/or processes may be utilized in accordance with embodiments of the disclosure. For example, the set of classification results may be provided as a feedback to the one or more encoders to refine and tune the one or more encoders for subsequent unified representation generation. The elements depicted in FIG. 9 may also be interchangeable with other elements of FIGS. 1-8 and 10-12 as required to realize a particularly desired embodiment.

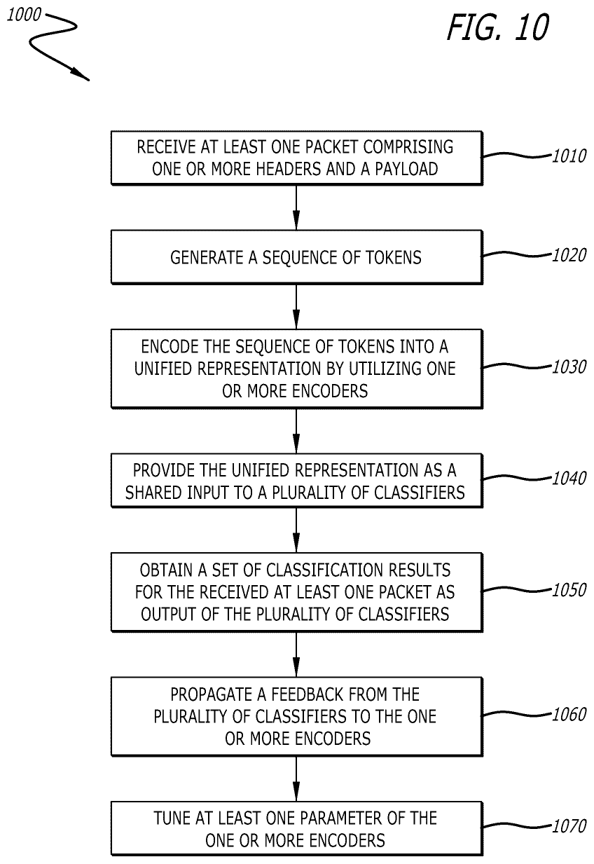

Referring to FIG. 10, a flowchart depicting a process 1000 for tuning network traffic classification in accordance with various embodiments of the disclosure is shown. An edge-based network device, such as an AP, associated with a network may be equipped with a packet inspection logic configured to adaptively tune network traffic classification for application recognition or intrusion detection. In many embodiments, the process 1000 may receive at least one packet comprising one or more headers and a payload (block 1010). In an example, the process 1000 may receive network traffic including a series of packets and the at least one packet may be one of the series of packets. The series of packets may be diverse in nature. In other words, packet structures of each packet may be different due to different protocol encapsulation and prevalence of encrypted payload. For example, the at least one packet can be a transmission control protocol (TCP) packet, a data packet, a control packet, a routing packet, a fragmented packet, IP packet, a user datagram protocol (UDP) packet, an internet control message protocol (ICMP) packet, an internet group message protocol (IGMP) packet, or the like.

In a number of embodiments, the process 1000 may generate a sequence of tokens (block 1020). In numerous embodiments, the process 1000 may generate the sequence of tokens based on the one or more headers and the payload of the packet. For example, the process 1000 may parse the packet into smaller, meaningful units, such as “tokens,” which can be individually analyzed. For example, in a web traffic packet, tokens might represent “HTTP,” “GET,” or specific query parameters. The one or more headers may be tokenized into one or more first tokens, while the payload may be tokenized into one or more second tokens. The one or more second tokens may be appended to the one or more first tokens to generate the sequence of tokens. If the payload has only plaintext, the payload may be directly tokenized to the one or more second tokens, while encrypted payloads may be first converted into intermediate codes and then tokenized to the one or more second tokens. The intermediate codes may be hexadecimal codes, binary codes, ASCII codes, unicode, or the like.

In more embodiments, the process 1000 may encode the sequence of tokens into a unified representation by utilizing one or more encoders (block 1030). That is to say, the sequence of tokens may be passed through the one or more encoders, which may transform the sequence of tokens into the unified representation. The unified representation may be a numerical or vector representation suitable for machine learning models. The one or more encoders, such as embedding layers or transformer models, may be configured to ensure that the unified representation capture both semantic pattern and a byte-level pattern within the received packet. In other words, the unified representation may include a first representation indicating the semantic pattern of the received packet, and one or more second representations indicating the byte-level pattern of the received packet.

In further embodiments, the process 1000 may provide the unified representation as a shared input to a plurality of classifiers (block 1040). The plurality of classifiers, each trained for a specific task, such as application recognition or intrusion detection, may analyze the same shared input data to produce task-specific outputs. The shared input approach may ensure that the plurality of classifiers operate on a consistent and comprehensive view of the received packet. For example, a first classifier may be an application recognition classifier that may be configured to determine that the received packet is part of a video streaming traffic, while a second classifier may be an intrusion detection classifier configured to detect whether the same received packet exhibits patterns associated with malicious activity. The plurality of classifiers may follow adaptive re-learning where an output from one classifier becomes an input to a re-learning phase of another classifier. In other words, the plurality of classifiers may be affected in the changes associated with each other and may adapt accordingly.

In still further embodiments, the process 1000 may obtain a set of classification results for the received at least one packet as output of the plurality of classifiers (block 1050). The set of classification results may include an application recognition output and an intrusion detection output. The application recognition output, generated by the application recognition classifier, may identify the application linked to the received packet. Similarly, the intrusion detection output, produced by the intrusion detection classifier, may determine whether the packet is legitimate or exhibits anomalous behavior. As the plurality of classifiers may be interconnected, the output of one classifier can influence the functioning of another, enabling the plurality of classifiers to adapt dynamically to changes in the network. Moreover, the unified representation may be shared as a common input across all classifiers, ensuring that each classifier may process the same unified representation of the packet for consistent analysis.

In several more embodiments, the process 1000 may propagate a feedback from the plurality of classifiers to the one or more encoders (block 1060). The feedback from the plurality of classifiers may enhance the performance of the one or more encoders by the alignment of the output of the one or more encoders with the classification tasks. For example, if the application recognition classifier was unable to distinguishing between two similar applications, such as video streaming and gaming, the feedback may guide the one or more encoders to fine-tune one or more parameters of the one or more encoders. The fine-tuning may involve adjusting how specific features, such as packet size or timing patterns, may be encoded into tokens, making them more distinct and relevant to the classification task.

In several additional embodiments, the process 1000 may tune at least one parameter of the one or more encoders (block 1070). In other words, the feedback from the plurality of classifiers may trigger updates to the at least one parameter of the one or more encoders, such as the weights or biases associated with the one or more encoders. The updates may be performed to minimize classification errors. By tuning the at least one parameter, the one or more encoders may become more effective at generating high-quality unified representations of packets for future analysis. For example, after tuning, the one or more encoders may develop a more refined ability to differentiate between benign and malicious traffic patterns.

Although a specific embodiment for fine tuning of network traffic classification suitable for carrying out the various steps, processes, methods, and operations described herein is discussed with respect to FIG. 10, any of a variety of systems and/or processes may be utilized in accordance with embodiments of the disclosure. For example, the feedback from the plurality of classifiers may be used to train an auxiliary model that may assist the one or more encoders in generating improved token representations. The elements depicted in FIG. 10 may also be interchangeable with other elements of FIGS. 1-9, 11, and 12 as required to realize a particularly desired embodiment.

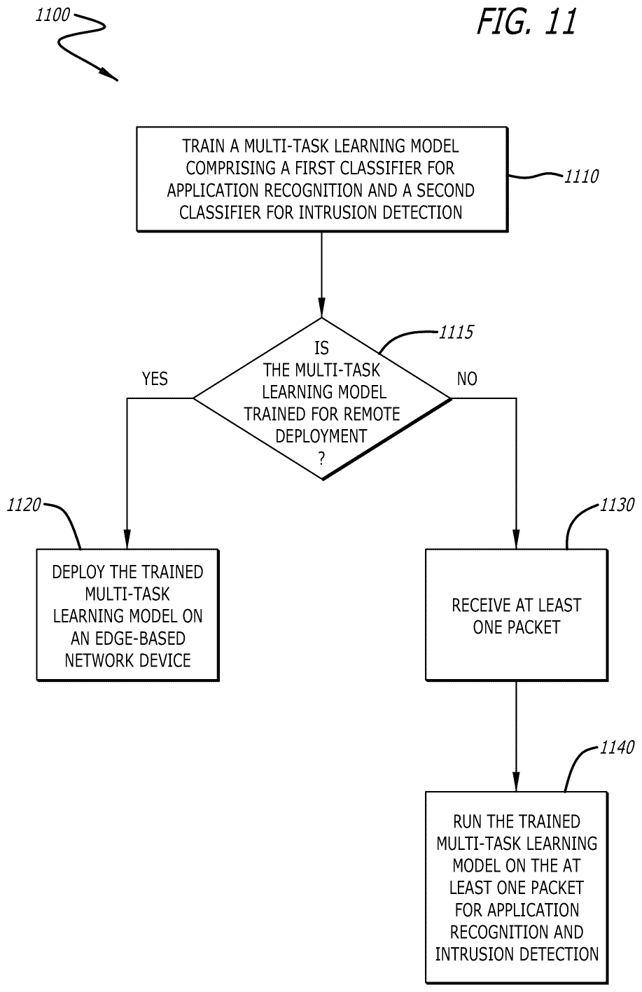

Referring to FIG. 11, a flowchart depicting a process 1100 for deploying a trained multi-task learning model in accordance with various embodiments of the disclosure is shown. In many embodiments, the process 1100 may train a multi-task learning (MTL) model comprising a first classifier for application recognition and a second classifier for intrusion detection (block 1110). The first classifier may be responsible for application recognition (e.g., identifying whether the traffic belongs to a video streaming application, a messaging application, or any other application category). The second classifier may be configured to detect intrusions or anomalies (e.g., identifying malicious traffic patterns such as a Distributed Denial of Service “DDoS” attack or packet injection). Training of the MTL model may involve providing synthetic traffic data to the first and the second classifiers as a shared input. “Synthetic traffic” may refer to artificially generated network data designed to mimic real-world applications or malicious patterns for testing and analysis purposes. The synthetic traffic may further include historical network traffic data received by a plurality of APs in the network. In several embodiments, the MTL model may utilize a neural network structure where each task operates on its own segment of a shared layer (e.g. a top portion and a bottom portion of the neural network structure), with distinct activation functions tailored to specific tasks. For instance, a first portion of the MTL model may perform Task 1 (e.g., the application recognition task) with one activation function, while a second portion of the MTL model may handle Task 2 (e.g., the intrusion detection task), utilizing both common and task-specific inputs. The output from the first portion of the MTL model can feed into the second portion and vice versa, contributing to a learning phase of the MTL model. The dynamic interaction may enable the output of the first portion or the second portion to act as either an excitatory function (activating the next layer with values near 1) or an inhibitory function (deactivating with values near 0), based on weights learned by the MTL model.

In a number of embodiments, the process 1100 may determine whether the MTL model is trained for remote deployment (block 1115). In other words, the process 1100 may check if the MTL model has achieved sufficient accuracy and robustness to be deployed on an edge-based device. For example, if the application recognition classifier correctly identifies 95% of network traffic and the intrusion detection classifier detects 90% of malicious patterns, the MTL model may be considered ready. However, if the performance falls below the threshold (e.g., only 70% accuracy in intrusion detection), further training or refinement may be needed. That is to say, in more embodiments, the process 1100 may continue training the multi-task learning model.

If the MTL model is trained for remote deployment, in a variety of embodiments, the process 1100 may deploy the trained MTL model on an edge-based network device (block 1120). Accordingly, the MTL model may be deployed on the edge-based devices such as routers or internet of things (IoT) gateways, process data close to the source, reducing latency and offloading traffic from central servers. For example, in a smart home network, the MTL model may be deployed on a home router. The router can now identify and classify packets in real time, distinguishing between video streaming traffic, online gaming traffic, and potential threats such as port scanning attempts. Deployment ensures the edge-based device can process data locally, reducing the need for centralized processing and enhancing real-time decision-making.

In a variety of embodiments, if the MTL model is trained for local deployment, the process 1100 may receive at least one packet (block 1130). That is to say, the process 1100 may start receiving at least one packet for analysis. The packet may include one or more headers (e.g., source IP, destination IP, protocol type) and a payload (the actual data being transmitted). The at least one packet serves as input to the trained MTL model for further classification of the at least one packet.

In additional embodiments, the process 1100 may run the trained multi-task learning model on the at least one packet for application recognition and intrusion detection (block 1140). The application recognition classifier of the MTL model may analyze the packet to determine the type of application, such as “streaming”, “messaging”, or “gaming”. Simultaneously, the intrusion detection classifier may check for signs of malicious activity, such as unusual packet sizes, irregular payloads, or abnormal traffic patterns. For example, if a packet has an unusually high frequency of requests from the same IP, it may be flagged as a potential DDoS attack. The application recognition and the intrusion detection classifiers may work in tandem, ensuring the network traffic is accurately categorized and secured. For instance, if the intrusion detection classifier detects no threat, the packet may be forwarded to the appropriate destination; otherwise, it is flagged for further investigation or blocked.

Although a specific embodiment for deploying a trained MTL model suitable for carrying out the various steps, processes, methods, and operations described herein is discussed with respect to FIG. 11, any of a variety of systems and/or processes may be utilized in accordance with embodiments of the disclosure. For example, the trained MTL model may be deployed in APs or WLCs. The elements depicted in FIG. 11 may also be interchangeable with other elements of FIGS. 1-10 and 12 as required to realize a particularly desired embodiment.

Referring to FIG. 12, a conceptual block diagram of a device 1200 suitable for configuration with a packet inspection logic in accordance with various embodiments of the disclosure is shown. The embodiment of the conceptual block diagram depicted in FIG. 12 can illustrate a conventional server, switch, wireless LAN controller, AP, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 12 can also illustrate an AP, a switch, or a router in accordance with various embodiments of the disclosure. The device 1200 may, in many non-limiting examples, correspond to physical devices or virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, one or more processors 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200.

In a number of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The chipset 1206 can provide an interface to a random-access memory (“RAM”) 1208, which can be used as the main memory in the device 1200 in some embodiments. The chipset 1206 can further be configured to provide an interface to a computer-readable storage medium such as a read-only memory (“ROM”) 1210 or non-volatile RAM (“NVRAM”) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Additional embodiments of the device 1200 can be configured to operate in a networked environment using logical connections to remote computing devices and computer systems through a network, such as the network 1240. The chipset 1206 can include functionality for providing network connectivity through a network interface card (“NIC”) 1212, which may comprise a gigabit Ethernet adapter or similar component. The NIC 1212 can be capable of connecting the device 1200 to other devices over the network 1240. It is contemplated that multiple NICs 1212 may be present in the device 1200, connecting the device to other types of networks and remote systems.

In further embodiments, the device 1200 can be connected to a storage 1218 that provides non-volatile storage for data accessible by the device 1200. The storage 1218 can, for instance, store an operating system 1220 and programs 1222 (e.g., applications). The storage 1218 can be connected to the environment 1202 through a storage controller 1214 connected to the chipset 1206. In certain embodiments, the storage 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like.

In many more embodiments, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1200 can further read or access information from the storage 1218 by detecting the physical states or characteristics of one or more particular locations within the physical storage units.

In addition to the storage 1218 described above, the device 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, the operations performed by a cloud computing network, and or any components included therein, may be supported by one or more devices similar to device 1200. Stated otherwise, some or all of the operations performed by the cloud computing network, and or any components included therein, may be performed by one or more devices 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1218 can store other system or application programs and data utilized by the device 1200.

In many additional embodiments, the storage 1218 or other computer-readable storage media is encoded with computer-executable instructions which, when loaded into the device 1200, may transform it from a general-purpose computing system into a special-purpose computer capable of implementing the embodiments described herein. These computer-executable instructions may be stored as programs 1222 (e.g., an application) and transform the device 1200 by specifying how the processor(s) 1204 can transition between states, as described above. In some embodiments, the device 1200 has access to computer-readable storage media storing computer-executable instructions which, when executed by the device 1200, perform the various processes described above with regard to FIGS. 1-12. In certain embodiments, the device 1200 can also include computer-readable storage media having instructions stored thereupon for performing any of the other computer-implemented operations described herein.

In many further embodiments, the device 1200 may include a packet inspection logic 1224. The packet inspection logic 1224 can be configured to perform one or more of the various steps, processes, operations, and/or other methods that are described above. Often, the packet inspection logic 1224 can be a set of instructions stored within a non-volatile memory that, when executed by the processor(s) 1204 can carry out these steps, etc. In some embodiments, the packet inspection logic 1224 may be a client application that resides on a network-connected device, such as, but not limited to, a server, switch, personal or mobile computing device in a single or distributed arrangement. The packet inspection logic 1224 may be configured to receive at least one packet that may include one or more headers and a payload and generate a sequence of tokens based on the one or more headers and the payload. The sequence of tokens may further include one or more first tokens that may be generated based on the one or more headers and one or more second tokens that may be generated based on the payload. The payload may correspond to one of plaintext or encrypted text. If the payload corresponds to the encrypted text, the packet inspection logic 1224 may be configured to convert the encrypted text into one or more codes (e.g., hexadecimal, ASCII, Unicode, or the like) and then tokenize the one or more codes to generate the one or more second tokens.

The packet inspection logic 1224 may be further configured to encode the sequence of tokens into a unified representation by utilizing one or more encoders. The unified representation may indicate a semantic pattern and a byte-level pattern of the received at least one packet. The unified representation may further include a first representation indicating the semantic pattern of the received at least one packet, and one or more second representations indicating the byte-level pattern of the received at least one packet. The packet inspection logic 1224 may be then configured to provide the unified representation as a shared input to a plurality of classifiers. A first classifier of the plurality of classifiers may correspond to an application recognition classifier and a second classifier of the plurality of classifiers may correspond to an intrusion detection classifier. The packet inspection logic 1224 may obtain a set of classification results for the received at least one packet as output of the plurality of classifiers. The set of classification results may include an application recognition result indicating an application associated with the received at least one packet and an intrusion detection result indicating whether the received at least one packet is a legitimate packet or an anomalous packet. The application recognition result may be obtained as the output of the first classifier and the intrusion detection result may be obtained as the output of the second classifier. The packet inspection logic 1224 may be further configured to generate one or more context-aware alerts based on the set of classification results. Furthermore, the packet inspection logic 1224 may be configured to propagate a feedback from the plurality of classifiers to the one or more encoders and tune at least one parameter of the one or more encoders based on the propagated feedback.

In some embodiments, the storage 1218 can include packet data 1228. The packet data 1228 may refer to the information contained within a network packet, which may be a unit of data transmitted across a network. The packet data 1228 may include information about headers and payloads. The headers include metadata such as source and destination IP addresses, protocol type, and packet sequencing information, which help in routing and managing the data transfer. The payload contains the actual data being transmitted, such as text, images, or commands. Depending on the context, the payload may be in plaintext, encrypted format, or compressed form.

In various embodiments, the storage 1218 can include representation data 1230. The representation data 1230 may refer to a unified representation of raw packet data, structured in a way that machines can process and analyze effectively. In the context of machine learning, representation data may be often derived from features extracted from raw inputs, such as text, images, or network packets. Herein, the representation data 1230 may include an encoded version of the sequence of tokens generated from packet headers and payloads utilizing one or more encoders. The representation data 1230 may thus include unified representations of network packets that may be suitable for downstream tasks such as classification, clustering, or prediction. The unified representations may further include semantic and byte level patterns of the network packets.

In a number of embodiments, the storage 1218 can include classification data 1232. The classification data 1232 may include output data generated by a plurality of classifiers. For example, the classification data may include labels such as “streaming application”, “FTP” or “web application” for application recognition and “attacked” or “intact” for intrusion detection. The classification data 1232 may be derived by analyzing the representation data 1230 utilizing the plurality of classifiers.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display, a digital projector, a printer, or other type of output device. Those skilled in the art will recognize that the device 1200 might not include all of the components shown in FIG. 12 and can include other components that are not explicitly shown in FIG. 12 or might utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

Finally, in numerous additional embodiments, data may be processed into a format usable by a ML model 1226 (e.g., feature vectors), and or other pre-processing techniques. The ML model 1226 may be any type of ML model, such as supervised models, reinforcement models, and/or unsupervised models. The ML model 1226 may include one or more of linear regression models, logistic regression models, decision trees, Naïve Bayes models, neural networks, k-means cluster models, random forest models, and/or other types of ML models 1226. In an example, the ML model 1226 may include the plurality of classifiers, each trained for a specific task such as application recognition and intrusion detection, that share common encoder(s).

The ML model(s) 1226 can be configured to generate inferences to make predictions or draw conclusions from data. An inference can be considered the output of a process of applying a model to new data. This can occur by learning from at least the packet data 1228, the representation data 1230, and the classification data 1232. These predictions are based on patterns and relationships discovered within the data. To generate an inference, the trained model can take input data and produce a classification result. The input data can be in various forms, such as images, audio, text, or numerical data, network packet data depending on the type of problem the model was trained to solve. The output of the model can also vary depending on the problem, and can be a single number, a probability distribution, a set of labels, a decision about an action to take, etc. Ground truth for the ML model(s) 1226 may be generated by human/administrator verifications or may compare predicted outcomes with actual outcomes. In several embodiments, the ML model(s) 1226 may be configured to determine the classification data 1232 based on the representation data 1230. Further, the ML model(s) 1226 may be configured to identify the packet data 1228 for generating the sequence of tokens based on the historical packet data received by a plurality of APs. For example, the ML model(s) 1226 may examine historical packet data or synthetic traffic data to identify patterns or trends. By learning from historical packet data and synthetic traffic data, the ML model(s) 1226 can classify the packet data with a high probability of classifying into accurate categories of application recognition or intrusion detection. In other words, once trained, the ML model(s) 1226 may be further deployed on the device 1200 (e.g., an edge-based network device) for network packet classification.

Although a specific embodiment for a device suitable for configuration with the networking logic for carrying out the various steps, processes, methods, and operations described herein is discussed with respect to FIG. 12, any of a variety of systems and/or processes may be utilized in accordance with embodiments of the disclosure. For example, the device 1200 may be in a virtual environment such as a cloud-based network administration suite, or it may be distributed across a variety of network devices or APs. The elements depicted in FIG. 12 may also be interchangeable with other elements of FIGS. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A network device, comprising:
a processor;
a network interface controller configured to provide access to a network; and
a memory communicatively coupled to the processor, wherein the memory comprises a packet inspection logic configured to:
receive at least one packet comprising one or more headers and a payload;
generate a sequence of tokens based on the one or more headers and the payload;
encode the sequence of tokens into a unified representation by utilizing one or more encoders;
provide the unified representation as a shared input to a plurality of classifiers; and
obtain a set of classification results for the received at least one packet as output of the plurality of classifiers.

2. The network device of claim 1, wherein the sequence of tokens comprises one or more first tokens that are generated based on the one or more headers and one or more second tokens that are generated based on the payload.

3. The network device of claim 2, wherein the payload corresponds to one of plaintext or encrypted text.

4. The network device of claim 3, wherein based on the payload corresponding to the encrypted text, generating the one or more second tokens comprises:
converting the encrypted text into one or more codes; and
tokenizing the one or more codes to generate the one or more second tokens.

5. The network device of claim 1, wherein the unified representation indicates a semantic pattern and a byte-level pattern of the received at least one packet.

6. The network device of claim 5, wherein the unified representation comprises:
a first representation indicating the semantic pattern of the received at least one packet, and
one or more second representations indicating the byte-level pattern of the received at least one packet.

7. The network device of claim 6, wherein a second representation of the one or more second representations corresponds to a token of the sequence of tokens.

8. The network device of claim 1, wherein the packet inspection logic is further configured to generate one or more context-aware alerts based on the set of classification results.

9. The network device of claim 1, wherein the packet inspection logic is further configured to:
propagate a feedback from the plurality of classifiers to the one or more encoders; and
tune at least one parameter of the one or more encoders based on the propagated feedback.

10. The network device of claim 1, wherein the network device corresponds to an access point in the network.

11. The network device of claim 1, wherein a first classifier of the plurality of classifiers corresponds to an application recognition classifier and a second classifier of the plurality of classifiers corresponds to an intrusion detection classifier.

12. The network device of claim 11, wherein the set of classification results includes an application recognition result indicating an application associated with the received at least one packet and an intrusion detection result indicating whether the received at least one packet is a legitimate packet or an anomalous packet.

13. The network device of claim 12, wherein the application recognition result is obtained as the output of the first classifier and the intrusion detection result is obtained as the output of the second classifier.

14. The network device of claim 1, wherein the plurality of classifiers corresponds to adaptive classifiers that re-learn based on the set of classification results.

15. A device, comprising:
a processor;
a memory communicatively coupled to the processor, wherein the memory comprises a packet inspection logic configured to:
train a multi-task learning model comprising a first classifier for application recognition and a second classifier for intrusion detection, wherein during training:
the first classifier generates an application recognition output and utilizes the application recognition output as one of an excitatory influence or an inhibitory influence on the second classifier, and
the second classifier generates an intrusion detection output and utilizes the intrusion detection output as one of an excitatory influence or an inhibitory influence on the first classifier.

16. The device of claim 15, wherein the packet inspection logic is further configured to deploy the trained multi-task learning model on an edge-based network device for network traffic classification.

17. The device of claim 15, wherein the device corresponds to an edge-based network device.

18. A network traffic classification method, comprising:
at an edge device in a network:
receiving at least one packet comprising one or more headers and a payload;
generating a sequence of tokens based on the one or more headers and the payload;
encoding the sequence of tokens into a unified representation by utilizing one or more encoders at the edge device;
providing the unified representation as a shared input to a plurality of classifiers at the edge device; and
obtaining a set of classification results for the received at least one packet as output of the plurality of classifiers.

19. The network traffic classification method of claim 18, wherein the set of classification results includes an application recognition result indicating an application associated with the received at least one packet and an intrusion detection result indicating whether the received at least one packet is a legitimate packet or an anomalous packet.

20. The network traffic classification method of claim 18, further comprising generating one or more context-aware alerts based on the set of classification results.
